(19) United States
(12) Patent Application Publication
(10) Pub. No.: US 2015/0125683 A1
(43) Pub. Date: May 7, 2015

(54) GYPSUM PRODUCTS COMPRISING SILICA GEL

(71) Applicant: United States Gypsum Company, Chicago, IL (US)

(72) Inventors: Bangji CAO, Naperville, IL (US); Weixin D. SONG, Vernon Hills, IL (US); Alfred LI, Naperville, IL (US)

(73) Assignee: United States Gypsum Company, Chicago, IL (US)

(21) Appl. No.: 14/072,592

(22) Filed: Nov. 5, 2013

(51) Int. Cl. B32B 13/04; E04C 2/34; E04C 2/04

(52) U.S. Cl. CPC B32B 13/04; E04C 2/043; E04C 2/34
USPC 428/219; 156/39

(57) ABSTRACT

A gypsum composition, board, and method of producing a gypsum board with increased fire endurance are described. The set gypsum-containing composition can be used to prepare a gypsum board having fire endurance, based on the inclusion of silica gel.

### BACKGROUND OF THE INVENTION

Gypsum products can be generally manufactured using a slurry formed from at least water and stucco. The stucco, which is calcium sulfate hemihydrate (CaSO₄.½H₂O), reacts with water to form gypsum, which is calcium sulfate dihydrate (CaSO₄.2H₂O). Gypsum wallboard can be a composite board comprising a core, face sheet, and back sheet. The density of gypsum wallboard can be reduced by adding aqueous foam to the stucco slurry in an amount effective to provide the desired gypsum core density. As the board contains less gypsum per unit volume, there is less crystallized water available to extend fire endurance of the wallboard. Gypsum wallboards are commonly used in drywall construction of interior walls and ceilings, and should be able to withstand both fire and excessive temperatures. As a result, gypsum wallboards are manufactured using specifications that maximize fire endurance/resistance.

Fire endurance/resistance of gypsum wallboard is measured by the period for which a board can withstand a standard fire test. The fire resistance of a wallboard is classified according to the ability for a wallboard to avoid an increase in temperature, flame passage, and structural collapse. In order to have various parties, including constructors, occupants, and regulating bodies, evaluate the fire endurance on a common basis, fire test assemblies are categorized into several standard arrangements. Some common assemblies include test designs defined by Underwriters Laboratories, Inc. (UL®), a testing and certification agency, which has tests that are referred to as U305, U419, and U423.

A standard fire test is customarily conducted in accordance with the requirements of ASTM E119. In such tests, a fire resistance classification can be established based on the time at which a wall assembly shows excessive temperature rise, or passage of flame, or structural collapse. Failure of such tests occur when the average temperature as measured by several thermocouples on the unexposed surface increases more than 250° F. (121° C.) above ambient temperature, or when any individual thermocouple rises more than 325° F. (163° C.) above ambient temperature. The duration of fire endurance of a system is not only dependent upon the gypsum board used in the system, but also upon many other factors, including wall assembly thickness, stud type and spacing, board size, insulation type, and other parameters.

Although existing techniques are useful in extending wallboard fire endurance and resistance, further improvement is always desirable.

### BRIEF SUMMARY OF THE INVENTION

In one aspect, the present invention provides a gypsum board comprising a set gypsum composition disposed between two cover sheets. The set gypsum composition comprises an interlocking matrix of set gypsum formed from a slurry comprising at least stucco, water, and metal silicate. The set gypsum composition comprises silica gel. The gypsum board has a density from about 15 lbs/ft³ to about 42 lbs/ft³ and a Fire Endurance Index greater than about 53 minutes.

In another aspect, the present invention provides a method of increasing fire endurance of a gypsum board comprising forming a slurry comprising stucco, water, and metal silicate, disposing the slurry between two cover sheets to form a board preform, cutting the board preform into a gypsum board of predetermined dimensions after the slurry has hardened sufficiently for cutting, and drying the gypsum board. At least a portion of the metal silicate converts to silica gel. The gypsum board has increased fire endurance as compared to a board having no silica gel, a density from about 15 lbs/ft³ to about 42 lbs/ft³, and a Fire Endurance Index greater than about 53 minutes.

These and other advantages of the present invention, as well as additional inventive features, will be apparent from the description that follows.

### BRIEF DESCRIPTION OF THE DRAWINGS

FIG. 1 is a scatter plot displaying the Fire Endurance Index (FEI) (Y-axis) over a range of vermiculite wt. % (X-axis) for wallboards in accordance with embodiments of the invention.

FIG. 2 is a diagram displaying the structure of the small scale test device used to determine the FEI of a wallboard sample in accordance with embodiments of the invention.

FIG. 3 is a line graph displaying the temperature profile (Y-axis) over time (X-axis) of a furnace used during the small scale fire test illustrated in FIG. 2, in accordance with embodiments of the invention.

FIG. 4 is a line graph displaying a correlation between fire endurance of U419 test (Y-axis) and fire endurance of small-scale test of FIG. 2 (X-axis) in accordance with embodiments of the invention.

FIG. 5 is a line graph displaying the FEI (Y-axis) over a range of silicate wt. % (X-axis) for wallboards of Example 2 during a small-scale fire test in accordance with embodiments of the invention.

FIG. 6 is a line graph displaying the unexposed surface temperature (Y-axis) over time (X-axis) for wallboards of Example 2 during a small-scale fire test in accordance with embodiments of the invention.

FIG. 7 is a line graph displaying the FEI (Y-axis) over a range of silicate wt. % (X-axis) for wallboards of Example 3 during a small-scale fire test in accordance with embodiments of the invention.

FIG. 8 is a line graph displaying the unexposed surface temperature (Y-axis) over time (X-axis) for wallboards of Example 3 during a small-scale fire test in accordance with embodiments of the invention.

FIG. 9 is a scatter plot displaying the board compressive strength (Y-axis) over a range of silicate wt. % (X-axis) for wallboards of Example 3 during a small-scale fire test in accordance with embodiments of the invention.

FIG. 10 is a line graph displaying the FEI (Y-axis) over a range of silicate wt. % (X-axis) for wallboards of Example 4 during a small-scale fire test in accordance with embodiments of the invention.

FIG. 11 is a scatter plot displaying the board compressive strength (Y-axis) over a range of silicate wt. % (X-axis) for wallboards of Example 5 during a small-scale fire test in accordance with embodiments of the invention.

### DETAILED DESCRIPTION OF THE INVENTION

Embodiments of the present invention are premised, at least in part, on the discovery that gypsum product (e.g., gypsum wallboard) comprising silica gel surprisingly and unexpectedly can have improved fire endurance and compressive strength. In accordance with embodiments of the invention, it has been found that when metal silicates are added to stucco slurry (comprising water, stucco, and optional additives as desired), silica gel can form in situ during the manufacturing process. The polymeric, highly cross-linked network of silica gel can impart both fire endurance and strength to a gypsum matrix. While not wishing to be bound by any particular theory, it is believed that the hydrophilic character of silica gel and nanoscale interactions between silica gel and the gypsum result in increased fire endurance and strength, respectively. The products of the present invention can have greater fire endurance and compressive strength than a product of equivalent density (and thickness in the case of board) having no or reduced amounts of silica gel. The gypsum product can be in the form of wallboard, ceiling panel (e.g., ceiling tile or board), acoustical tile, joint compound, or the like.

It is understood that silica gel is a porous form of silicon dioxide that can be synthetically prepared from metal silicates. Silica gels are amorphous solids generally used as dessicants and filtration agents due to their ability to adsorb water and other small molecules. The partial dipole in the Si—O bond allows silica gel to hydrogen bond with water molecules while the porous nature and large surface area of silica gel enables the material to readily adsorb water. In accordance with embodiments of the present invention, metal silicates can form silica gel in situ during the manufacture of gypsum products.

Metal silicate can convert to silica gel in stucco slurry, producing a gypsum board with increased fire endurance and strength. In the art, it is generally believed that light weight gypsum board is especially prone to shrinkage under high thermal conditions. Since silica gel can decrease in volume at high temperatures, such as when exposed to a fire, it was surprisingly and unexpectedly discovered that silica gel can increase the fire endurance of lightweight board while experiencing only minimal shrinkage during a fire test. Thus, in some embodiments, metal silicates can be added to a gypsum slurry to form light weight gypsum board (e.g., board density less than about 42 lb/ft³, less than about 40 lb/ft³, less than about 38 lb/ft³, less than about 35 lb/ft³, less than about 33 lb/ft³, and lower).

Any suitable metal silicate can be added to a stucco composition to increase the fire endurance and compressive strength of gypsum products. For example, in some embodiments, the metal is sodium, potassium, or lithium. In some embodiments, a combination of different metal silicates can be added to the stucco composition in the form of a slurry to increase the fire endurance and compressive strength of gypsum products. Any metal silicate that can convert to silica gel is suitable for the present invention. For example, alkali metal silicates such as sodium silicate, potassium silicate, lithium silicate, or any combination thereof are suitable for the present invention.

Metal silicates or a mixture of metal silicates can be added to stucco in any suitable amount. The metal silicate can be added by itself (in a solid form) or in a wet form, such as a slurry or solution. Unless otherwise stated, it will be understood that the amount of metal silicates described herein refers to the active, undiluted weight of the metal silicate, not the weight of the overall solution or slurry that might contain the metal silicate.

In some embodiments, metal silicate is added in an amount greater than about 0.01% by weight based on the weight of stucco. For example, metal silicate can be added in an amount from about 0.01% to about 5% by weight based on the weight of stucco. In other embodiments, metal silicate is added to stucco in an amount from about 0.01% to about 1% by weight based on the weight of stucco. In embodiments of the invention, the amount of metal silicate added to stucco can be, e.g., as listed in Tables 1A and 1B. In the tables, an “X” represents the range “from about [corresponding value in top row] to about [corresponding value in left-most column].” The indicated values represent the amount of metal silicate added by weight based on the weight of stucco. For ease of presentation, it will be understood that each value represents “about” that value. For example, the first “X” in Table 1A is the range “from about 0.01% to about 0.05%.” The ranges of the tables are between and including the starting and endpoints.

TABLE 1A

| | | Starting Point for Metal Silicate Range (%) | | | | | | | | | |
|---|---|---|---|---|---|---|---|---|---|---|---|
| | | 0.01 | 0.05 | 0.1 | 0.15 | 0.2 | 0.25 | 0.3 | 0.35 | 0.4 | 0.45 |
| End Point for Metal | 0.05 | X | | | | | | | | | |
| Silicate Range (%) | 0.1 | X | X | | | | | | | | |
| | 0.15 | X | X | X | | | | | | | |
| | 0.2 | X | X | X | X | | | | | | |
| | 0.25 | X | X | X | X | X | | | | | |
| | 0.3 | X | X | X | X | X | X | | | | |
| | 0.35 | X | X | X | X | X | X | X | | | |
| | 0.4 | X | X | X | X | X | X | X | X | | |
| | 0.45 | X | X | X | X | X | X | X | X | X | |
| | 0.5 | X | X | X | X | X | X | X | X | X | X |
| | 0.55 | X | X | X | X | X | X | X | X | X | X |
| | 0.6 | X | X | X | X | X | X | X | X | X | X |
| | 0.65 | X | X | X | X | X | X | X | X | X | X |
| | 0.7 | X | X | X | X | X | X | X | X | X | X |
| | 0.75 | X | X | X | X | X | X | X | X | X | X |
| | 0.8 | X | X | X | X | X | X | X | X | X | X |
| | 0.85 | X | X | X | X | X | X | X | X | X | X |
| | 0.9 | X | X | X | X | X | X | X | X | X | X |
| | 0.95 | X | X | X | X | X | X | X | X | X | X |
| | 1 | X | X | X | X | X | X | X | X | X | X |

TABLE 1B

| | | Starting Point for Metal Silicate Range (%) | | | | | | | | | |
|---|---|---|---|---|---|---|---|---|---|---|---|
| | | 0.5 | 0.55 | 0.6 | 0.65 | 0.7 | 0.75 | 0.8 | 0.85 | 0.9 | 0.95 |
| End Point for Metal | 0.55 | X | | | | | | | | | |
| Silicate Range (%) | 0.6 | X | X | | | | | | | | |
| | 0.65 | X | X | X | | | | | | | |
| | 0.7 | X | X | X | X | | | | | | |
| | 0.75 | X | X | X | X | X | | | | | |
| | 0.8 | X | X | X | X | X | X | | | | |
| | 0.85 | X | X | X | X | X | X | X | | | |
| | 0.9 | X | X | X | X | X | X | X | X | | |
| | 0.95 | X | X | X | X | X | X | X | X | X | |
| | 1 | X | X | X | X | X | X | X | X | X | X |

In some embodiments, the metal silicate component can be sodium silicate, also known as water glass or liquid glass, which is converted to the silica gel. In these embodiments, the sodium silicate can be used as the only metal silicate component, or alternatively, in combination with another metal silicate. It will be understood that sodium silicate is a basic inorganic compound commonly used to manufacture both industrial and consumer products. Since it is readily soluble in water, sodium silicate is often sold as an aqueous solution.

Metal silicates used in accordance with the invention can be prepared in any suitable manner. For example, to illustrate, in some embodiments, sodium silicate can be made by fusing high purity silica sand (SiO₂) and soda ash (Na₂CO₃) in an open hearth furnace at high temperature. First, soda ash and silica sand are melted at 1100° C. to 1300° C. to produce an amorphous solid glass known as cullet, which consists of a mixture of SiO₂ and Na₂O. Second, cullet is dissolved in water while under pressure in a vessel. The resulting solution is sometimes called water glass and can be used directly in the stucco slurry in some embodiments of the invention. In some embodiments, the properties of products comprising silicates can be manipulated by varying the SiO₂/Na₂O weight ratio. If desired, the SiO₂/Na₂O ratio can be altered by adding different amounts of sodium hydroxide (NaOH) to water glass. Other metal silicates are generally prepared in the same manner. Metal silicates are generally commercially available as a solution or in the solid phase, and can have a wide range of properties.

Metal silicate is often used as a general term for water solutions of SiO₂ and MₓO (where M is a metal and x≧1) combined in various ratios, and can be identified by grade based on the SiO₂/MₓO ratio of the solution. To illustrate, sodium silicate can be the general term for water solutions of SiO₂ and Na₂O combined in various ratios, and can be identified by grade based on the SiO₂/Na₂O ratio of the solution.

The SiO₂ to metal oxide ratio of the present invention can be of any suitable ratio. In some embodiments, the SiO₂ to metal oxide ratio is from about 0.5 to about 5. In other embodiments, the SiO₂ to metal oxide ratio is from about 2 to about 4. In embodiments of the invention, the SiO₂ to metal oxide ratio can be, e.g., as listed in Table 2. In the table, an “X” represents the range “from about [corresponding value in top row] to about [corresponding value in left-most column].” The indicated values represent the SiO₂ to metal oxide ratio (Table 2). For ease of presentation, it will be understood that each value represents “about” that value. For example, the first “X” in Table 2 is the range “from about 0.5:1 to about 1:1.” The ranges of the table are between and including the starting and endpoints.

TABLE 2

| | | Starting Point for SiO₂ to Metal Oxide Ratio Range | | | | | | | | |
|---|---|---|---|---|---|---|---|---|---|---|
| | | 0.5:1 | 1:1 | 1.5:1 | 2:1 | 2.5:1 | 3:1 | 3.5:1 | 4:1 | 4.5:1 |
| End Point | 1:1 | X | | | | | | | | |
| for SiO₂ | 1.5:1 | X | X | | | | | | | |
| to Metal | 2:1 | X | X | X | | | | | | |
| Oxide | 2.5:1 | X | X | X | X | | | | | |
| Ratio | 3:1 | X | X | X | X | X | | | | |
| Range | 3.5:1 | X | X | X | X | X | X | | | |
| | 4:1 | X | X | X | X | X | X | X | | |
| | 4.5:1 | X | X | X | X | X | X | X | X | |
| | 5:1 | X | X | X | X | X | X | X | X | X |

The metal silicate solution added to stucco can have any suitable pH. In accordance with some embodiments of the invention, it has been found that gypsum products, such as wallboard, made by combining stucco with a metal silicate solution that has a pH less than about 10 imparts improved fire endurance and compressive strength to the gypsum product. Thus, in some embodiments, the metal silicate solution has a pH of from about 5 to about 10, such as from about 5 to about 9, from about 5 to about 8, from about 5 to about 7, from about 5 to about 6, from about 6 to about 10, from about 6 to about 9, from about 6 to about 8, from about 6 to about 7, from about 7 to about 10, from about 7 to about 9, or from about 7 to about 8.

For example, in some embodiments, the pH of the metal silicate solution added to stucco is from at least about 5 to less than about 10. It has been found that in some embodiments, such as in the case of sodium silicate, solutions having a pH of about 10 or above (e.g., pH from about 10 to about 13) can result in a retardive effect during the formation of gypsum from stucco. Thus, in some embodiments, the composition, wallboard, or method can be “substantially free” of silicates having a pH of at least about 10, which means that the composition, wallboard, or method contains either (i) 0 wt. % based on the weight of stucco, or no such silicates having a pH of at least about 10, or (ii) an ineffective or (iii) an immaterial amount of silicate having a pH of at least about 10. An example of an ineffective amount is an amount below the threshold amount to achieve the intended purpose of using silicates having a pH of at least about 10 as one of ordinary skill in the art will appreciate. An amount may be, e.g., below about 0.5 wt. %, such as below about 0.2 wt. %, below about 0.1 wt. %, or below about 0.01 wt. % based on the weight of stucco as one of ordinary skill in the art will appreciate.

However, if desired in alternative embodiments, a metal silicate solution having a pH of at least about 10 can be used in the composition, wallboard, or method, especially where any retardive effect is accepted or mitigated. In some embodiments, it has been found that a metal silicate solution having a pH greater than about 10 can increase fire endurance and compressive strength. Thus in some embodiments, the pH of the metal silicate solution can be from about 10 to about 13, such as from about 10 to about 12, from about 10 to about 11, from about 11 to about 13, from about 11 to about 12, or from about 12 to about 13. In some embodiments, the composition, wallboard, or method can be “substantially free” of silicates having a pH less than about 10, which means that the composition, wallboard, or method contains either (i) 0 wt. % based on the weight of stucco, or no such silicates having a pH less than about 10, or (ii) an ineffective or (iii) an immaterial amount of silicate having a pH less than about 10. An example of an ineffective amount is an amount below the threshold amount to achieve the intended purpose of using silicates having a pH less than about 10 as one of ordinary skill in the art will appreciate. An amount may be, e.g., below about 0.5 wt. %, such as below about 0.2 wt. %, below about 0.1 wt. %, or below about 0.01 wt. % based on the weight of stucco as one of ordinary skill in the art will appreciate.

In some embodiments, metal silicates can be converted in situ in stucco slurry to form silica gel via the water glass technique. During the water glass process, an acid is added to silicates to lower the pH, which leads to hydrolysis of the silicate to form silicic acid. Silanol groups (—Si—OH) of silicic acid molecules can spontaneously condense to form a polymer (i.e., silica gel). The tetravalent nature of silicon allows silicic acid to form four new silicon-oxygen bonds, which can generate a highly crosslinked silicon-based polymer. Through this process, the molecules become a large 3-dimensional network.

Metal silicates are neutralized with acid prior to stucco addition in some embodiments. For the process of board manufacture, it is preferable that silica gel formation occurs from about 2 minutes to about 120 minutes after acid has been added to the metal silicate. For practical board manufacture, the silicate solution must have good fluidity before adding to the stucco slurry because the silicate solution is pumped into the stucco composition. If the silicate gels prior to pumping, the silicate will be difficult to pump. Gel formation time is dependent upon factors including the initial concentration of the metal silicate solution, pH of the solution after acid addition, SiO₂/Na₂O ratio, and type/concentration of acid used.

In some embodiments, before the addition of acid, the metal silicate solution is diluted with water to obtain the desired concentration. In other embodiments, before the addition of acid, solid metal silicate is mixed with water to obtain a solution having the desired concentration. The metal silicate solution can be of any sufficient concentration. In some embodiments, the metal silicate solution has a concentration from about 0.1% to about 10% based on the amount of metal silicate in water. In other embodiments, the metal silicate solution has a concentration from about 0.1% to about 4%. The concentration of the metal silicate solution is preferably from about 3% to about 4%.

Any sufficient acid can be added to metal silicate for neutralization. For example, acids such as nitric acid, acetic acid, and hydrolyzed aluminum sulfate can be used. In some embodiments, strong acids such as hydrochloric acid (20% concentration) and sulfuric acid (98% concentration) are used. For the present invention, sulfuric acid is generally preferable to hydrochloric acid because the presence of chloride ions can be detrimental to board strength.

In preferred embodiments, a sufficient amount of acid is added to the silicate solution to form a solution having a pH from about 5 to about 10. In some embodiments, the pH of the silicate solution decreases when combined with a stucco slurry. Gel formation is most rapid when silicate solutions have a pH from about 5 to about 8. In some embodiments, sufficient acid is added to the silicate solution to form a solution having a pH from about 6 to about 8. In embodiments of the invention, the pH of the silicate solution after the addition of acid to silicates can be, e.g., as listed in Table 3. In the table, an “X” represents the range “from about [corresponding value in top row] to about [corresponding value in left-most column].” The indicated values represent the pH of the silicate solution after acid addition (Table 3). For ease of presentation, it will be understood that each value represents “about” that value. For example, the first “X” in Table 3 is the range “from about 5 to about 5.5.” The ranges of the table are between and including the starting and endpoints.

TABLE 3

| | | Starting Point for Silicate Solution pH Range | | | | | | | | | |
|---|---|---|---|---|---|---|---|---|---|---|---|
| | | 5 | 5.5 | 6 | 6.5 | 7 | 7.5 | 8 | 8.5 | 9 | 9.5 |
| Endpoint Point | 5.5 | X | | | | | | | | | |
| for Silicate | 6 | X | X | | | | | | | | |
| Solution pH | 6.5 | X | X | X | | | | | | | |
| Range | 7 | X | X | X | X | | | | | | |
| | 7.5 | X | X | X | X | X | | | | | |
| | 8 | X | X | X | X | X | X | | | | |
| | 8.5 | X | X | X | X | X | X | X | | | |
| | 9 | X | X | X | X | X | X | X | X | | |
| | 9.5 | X | X | X | X | X | X | X | X | X | |
| | 10 | X | X | X | X | X | X | X | X | X | X |

The silicate solution can be combined with at least stucco to form wallboard having greater fire endurance and strength. In some embodiments, a set gypsum composition is disposed between two cover sheets, the set gypsum composition comprising an interlocking matrix of set gypsum formed from a slurry comprising at least stucco, water, and metal silicate. In some embodiments, a metal silicate is combined with dry stucco. In other embodiments, the metal silicate solid or solution is added directly to a stucco slurry. The stucco slurry comprising silicates is disposed between two cover sheets. After the slurry has hardened sufficiently for cutting, the board preform is cut into a board of predetermined dimensions. The board is dried. While not wishing to be bound by any particular theory, it is believed that as the stucco hydrates to form gypsum, the concentration of silicates increase, initiating faster formation of silica gel. As the board is dried at high temperatures, the polymerization reaction to form silica gel can go to completion.

In some embodiments, silicates can be partially polymerized before being added to stucco. In other embodiments, silicates can partially polymerize while in the slurry, but become fully converted to silica gel when exposed to elevated temperature, e.g., in the kiln for the drying step to remove excess water. In some embodiments, the silicates are not fully polymerized, even upon exiting the kiln. Any sodium silicate to silica gel ratio is sufficient so long as the silica gel is in an amount effective to increase the compressive strength of the gypsum product relative to the compressive strength of a gypsum product without silica gel in accordance with the present invention.

As noted above, the degree of silicate polymerization to silica gel can be of any suitable amount, such as about 50% or more (i.e., a ratio of 1:1), 60% or more, 70% or more, 80% or more, 90% or more, 95% or more, and 99%, or more. However, smaller degrees of polymerization may not take full advantage of the fire endurance and strength enhancement, of some embodiments of the invention. Thus, in some embodiments, it is preferred that the set gypsum composition comprises silica gel in an amount greater than the amount of metal silicate in the set gypsum composition. In some embodiments, it is preferred that there is a ratio of silica gel to metal silicate in the set gypsum composition, e.g., at least about 2:1, at least about 3:1, at least about 4:1, at least about 5:1, at least about 10:1, at least about 20:1, at least about 50:1, at least about 75:1, at least about 80:1, at least about 90:1, at least about 95: 1, at least about 97:1, at least about 99:1, or fully polymerized (100%) to silica gel.

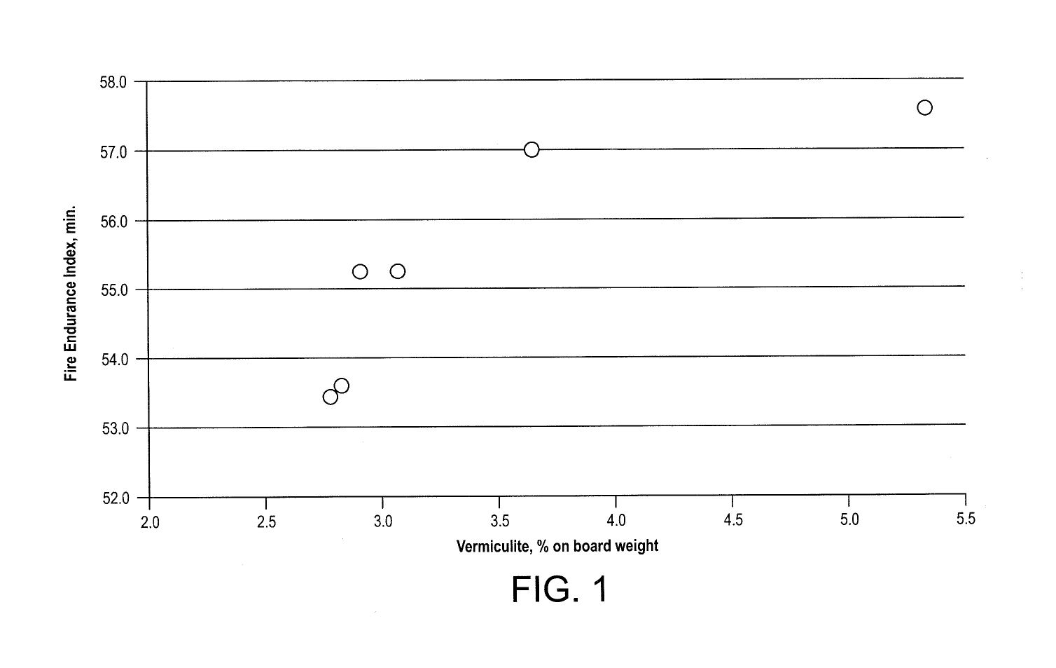

In some embodiments, high thermal expansion additives such as vermiculite can be added to a slurry formulation comprising metal silicate to improve fire endurance. As used herein, vermiculite is the term used for a group of hydrous silicate minerals of aluminum, magnesium, and iron, which can expand upon heating imparting greater fire endurance. However, when an excessive amount of vermiculite is used to make light weight board, the expansion of the vermiculite particles can lead to spalling and crumbling. High thermal expansion additives such as vermiculite can be costly to use and the effective increase in fire endurance often levels off after a specific vermiculite content threshold. As seen in FIG. 1, increasing the amount of vermiculite from 2.7 wt % to 3.6 wt % leads to a 3.5 minute increase in the Fire Endurance Index (FEI), while increasing the amount of vermiculite from 3.6 wt % to 5.4 wt % leads to less than a 1 minute increase in the FEI. As a result, the highest cost benefit is obtained when the vermiculite content is below about 3.6 wt %.

A combination of silicates and vermiculite can increase the fire endurance of a gypsum board in accordance with some embodiments. A reduced amount of high expansion particles, such as vermiculite, in combination with one or more metal silicate can be included in the stucco slurry in some embodiments. For example, one benefit is that vermiculite can decrease shrinkage in board comprising silica gel. Silica gel can convert to silica (SiO₂) at high temperatures, resulting in volume shrinkage of the gypsum article. Volume shrinkage in a gypsum composition leads to faster heat transfer through the gypsum core. The addition of high thermal expansion additives such as vermiculite can help to offset this shrinkage.

In some embodiments, a reduced amount of high expansion particles, such as vermiculite, is included. For example, fire rated board prepared using smaller amounts of vermiculite surprisingly and unexpectedly enhance fire endurance and, moreover, require less expenditure during manufacture. In some embodiments, the amount of vermiculite in the stucco slurry is about 5 wt. % or less, e.g., 4 wt. % or less, 3 wt. % or less, 2 wt. % or less, 1 wt. % or less, 0.5 wt. % or less, or 0.1 wt. % or less. Each of the aforementioned endpoints can have a lower limit, e.g., ranging from 0.001 wt. %, 0.01 wt. %, 0.05 wt. %, 0.1 wt. %, 0.5 wt. %, 1 wt. %, 1.5 wt. %, or 2 wt. %, as numerically appropriate.

In some embodiments, vermiculite can be added to the stucco composition in the form of a slurry in any sufficient amount. Relatively low expansion vermiculite, such as that referred to as “Grade No. 5” unexpanded vermiculite (with a typical particle size of less than about 0.0157 inches (0.40 mm)), or high expansion particulates in the form of vermiculite with a high volume of expansion relative to Grade No. 5 vermiculite (U.S. grading system), and other low expansion vermiculites may be utilized. In other embodiments, high expansion vermiculites can be used that are classified under different grading systems. Such high expansion vermiculites should have substantially similar expansion and/or thermal resistance characteristics typical of those discussed herein. For example, in some embodiments, a vermiculite classified as European, South American, or South African Grade 0 (micron) or Grade 1 (superfine) can be used.

In some embodiments, the high expansion vermiculite used can include commercial U.S. Grade 4 vermiculite commercially-available through a variety of sources. Commercial producers can provide specifications for physical properties of the high expansion vermiculite, such as Mohs hardness, total moisture, free moisture, bulk density, specific ratio, aspect ratio, cation exchange capacity, solubility, pH (in distilled water), expansion ratio, expansion temperature, and melting point, for example. It is contemplated that in different embodiments using different sources of high expansion vermiculites, these physical properties will vary.

In some embodiments, the high expansion vermiculite particles are generally distributed throughout the core portion of the gypsum panels. In other embodiments, the high expansion vermiculite particles are generally evenly distributed throughout the core portion of the gypsum panels. The high expansion vermiculite can be generally randomly distributed throughout any reduced density portions of the core. In some embodiments, it may be desirable to have a different vermiculite distribution in denser portions of a board, such as in any increased density gypsum layer adjacent the panel face(s) or in portions of the core with greater density along the panel edges. In other embodiments, the high expansion vermiculite may be substantially excluded from those denser portions of the panels, such as hardened edges and faces of the panels. Such variations in vermiculite particle contents and distribution in the denser portions of the panels may be as a result of drawing core slurry from the core slurry mixer for use in those portions of the panel, by introduction of the vermiculite through other appropriate means into the slurry for the reduced density core portions of the panel, by using edge mixers, or by other means known to those skilled in the art.

In embodiments of the invention, the amount of vermiculite can be, e.g., as listed in Table 4. In the table, an “X” represents the range “from about [corresponding value in top row] to about [corresponding value in left-most column].” The indicated values represent the wt. % of vermiculite based on the amount of stucco. For ease of presentation, it will be understood that each value represents “about” that value. For example, the first “X” in Table 4 is the range “from about 0% to about 0.2%.” The ranges of the table are between and including the starting and endpoints.

TABLE 4

| | | Starting Point for Vermiculite Range (%) | | | | | | | | | | |
|---|---|---|---|---|---|---|---|---|---|---|---|---|
| | | 0 | 0.2 | 0.5 | 1 | 1.5 | 2 | 2.5 | 3 | 3.5 | 4 | 4.5 |
| End Point | 0.2 | X | | | | | | | | | | |
| for Vermiculite | 0.5 | X | X | | | | | | | | | |
| Range (%) | 1 | X | X | X | | | | | | | | |
| | 1.5 | X | X | X | X | | | | | | | |
| | 2 | X | X | X | X | X | | | | | | |
| | 2.5 | X | X | X | X | X | X | | | | | |
| | 3 | X | X | X | X | X | X | X | | | | |
| | 3.5 | X | X | X | X | X | X | X | X | | | |
| | 4 | X | X | X | X | X | X | X | X | X | | |
| | 4.5 | X | X | X | X | X | X | X | X | X | X | |
| | 5 | X | X | X | X | X | X | X | X | X | X | X |

In some embodiments, silica gel can serve as a low cost alternative to high expansion materials such as vermiculite. Thus in some embodiments, the desired wallboard is formed from slurry that is substantially free of high expansion materials such as vermiculite. In addition, in some embodiments, the wallboard or method of preparing board can be “substantially free” of high expansion materials such as vermiculite, which means that the slurry, wallboard, or method contains either (i) 0 wt. % based on the weight of stucco, or no such high expansion materials such as vermiculite, or (ii) an ineffective or (iii) an immaterial amount of high expansion material such as vermiculite. An example of an ineffective amount is an amount below the threshold amount to achieve the intended purpose of using high expansion materials such as vermiculite as one of ordinary skill in the art will appreciate. An amount may be, e.g., below about 5 wt. %, such as below about 2 wt. %, below about 1 wt. %, below about 0.5 wt. %, below about 0.2 wt. %, below about 0.1 wt. %, or below about 0.01 wt. % based on the weight of stucco as one of ordinary skill in the art will appreciate. However, if desired in alternative embodiments, such ingredients can be included in the composition, wallboard, or method.

In some embodiments, the amount of metal silicate is effective to increase the compressive strength of the set gypsum core relative to the set gypsum core having metal silicate in an amount of less than about 0.01% by weight based on the weight of stucco. The board of the present invention has a compressive strength that can meet the standard of ASTM C1396, which references ASTM C473-10 test methods (e.g., ASTM C473-10, method B) in some embodiments. In embodiments of the invention, compressive strength can be, e.g., as listed in Table 5. In the table, an “X” represents the range “from about [corresponding value in top row] to about [corresponding value in left-most column].” The indicated values represent the compressive strength of a board in psi (Table 5). For ease of presentation, it will be understood that each value represents “about” that value. For example, the first “X” in Table 5 is the range “from about 200 psi to about 220 psi.” The ranges of the table are between and including the starting and endpoints.

TABLE 5

| | | Starting Point for Compressive Strength (psi) | | | | | | | | | | | |
|---|---|---|---|---|---|---|---|---|---|---|---|---|---|
| | | 200 | 220 | 240 | 260 | 280 | 300 | 320 | 340 | 360 | 380 | 400 | 420 |
| End Point for | 220 | X | | | | | | | | | | | |
| Compressive | 240 | X | X | | | | | | | | | | |
| Strength (psi) | 260 | X | X | X | | | | | | | | | |
| | 280 | X | X | X | X | | | | | | | | |
| | 300 | X | X | X | X | X | | | | | | | |
| | 320 | X | X | X | X | X | X | | | | | | |
| | 340 | X | X | X | X | X | X | X | | | | | |
| | 360 | X | X | X | X | X | X | X | X | | | | |
| | 380 | X | X | X | X | X | X | X | X | X | | | |
| | 400 | X | X | X | X | X | X | X | X | X | X | | |
| | 420 | X | X | X | X | X | X | X | X | X | X | X | |
| | 440 | X | X | X | X | X | X | X | X | X | X | X | X |

In general, when a gypsum wallboard is under thermal stress, thermal energy is initially directed to the evaporation of the calcium sulfate-bound water molecules. It is those two molecules of water that render gypsum highly resistant against heat. Upon reaching 215° F. (102° C.), water molecules are driven off, which leads to the formation of calcium sulfate hemihydrate. When the temperature reaches 250° F. (121° C.), the remaining water is lost as gypsum is converted into calcium sulfate anhydrite. Both reactions are endothermic, meaning gypsum will absorb heat as it is “calcined” from dihydrate to anhydrite. While not wishing to be bound by any particular theory, it is believed that the formation of a hydrophilic silica gel network throughout the core results in an improvement in fire endurance and compressive strength. It is further believed that during a fire, moisture released from the gypsum core during calcination is adsorbed onto the silica gel surface. It is believed that the additional energy required to evaporate the water from the silica gel surface effectively lowers the temperature of the board, leading to higher fire endurance. It is also believed that the three dimensional network of porous silica gel can effectively adsorb moisture at the nanoscale due to proximity to gypsum throughout calcination during a fire.

While not wishing to be bound by any particular theory, it is also believed that the three dimensional network of silica gel is distributed throughout the core and intertwined with the gypsum crystals at nanoscale. It is believed that the silica gel wraps around gypsum crystals, applying force to the gypsum crystals during the formation of gypsum board, which provides more lategrity to the core. It is believed that silica gel acts as a reinforcing network in the board structure to improve its compressive strength.

The amount of water in the stucco slurry can affect the fire endurance of the gypsum product, as disclosed in U.S. patent application Ser. No. 14/054,689, which is hereby incorporated by reference with regard to water-to-stucco ratios. In some embodiments, the slurry can have a water-to-stucco ratio of about 0.7 to about 2.0. In other embodiments, the slurry can have a water-to-stucco ratio of about 1.0 to about 2.0. In other embodiments, the slurry can have a water-to-stucco ratio of about 1.2 to about 2.0.

In an embodiment, the present invention provides a gypsum board which comprises a set gypsum composition disposed between two cover sheets, the set gypsum composition comprising an interlocking matrix of set gypsum formed from a slurry comprising at least stucco, water, and metal silicate. The slurry has a water-to-stucco ratio from about 1.2 to about 2.0. The gypsum board has a density from about 15 lbs/ft³ to about 42 lbs/ft³, a nail pull resistance of at least about 70 lbs of force as determined according to ASTM C473-09 (e.g., ASTM C473-09, method B), and a FEI greater than about 50 minutes.

The present invention can be practiced employing compositions and methods similar to those employed in the art to prepare various set gypsum-containing products. In the core, the stucco (or calcined gypsum) component used to form the crystalline matrix typically comprises, consists essentially of, or consists of beta calcium sulfate hemihydrate, water-soluble calcium sulfate anhydrite, alpha calcium sulfate hemihydrate, or mixtures of any or all of these, from natural or synthetic sources. In some embodiments, the stucco may include non-gypsum minerals, such as minor amounts of clays or other components that are associated with the gypsum source or are added during the calcination, processing and/or delivery.

The gypsum core may comprise conventional additives in the practice of the invention in customary amounts to impart desirable properties and to facilitate manufacturing, such as, for example, suitable aqueous foam, set accelerators, set retarders, recalcination inhibitors, binders, adhesives, leveling or nonleveling agents, bactericides, fungicides, pH adjusters, colorants, reinforcing materials, fire retardants, water repellants, fillers, dimensional strengtheners, and mixtures thereof. In some embodiments, dispersants such as naphthalenesulfonates, polycarboxylates, or hydroxyalkylated compounds can be used. In addition, the gypsum core can comprise additives such as phosphonic and/or phosphonate compounds, phosphoric and/or phosphate compounds, carboxylic and/or carboxylate compounds, and mixtures thereof.

Accelerators, as described in U.S. Pat. No. 6,409,825, herein incorporated by reference with respect to accelerators, can be used in the gypsum-containing compositions of the present invention. One desirable heat resistant accelerator (HRA) can be made from the dry grinding of landplaster (calcium sulfate dihydrate). Small amounts of additives (normally about 5% by weight) such as sugar, dextrose, boric acid, and starch can be used to make this HRA. Sugar, or dextrose, is currently preferred. Another useful accelerator is “climate stabilized accelerator” or “climate stable accelerator,” (CSA) as described in U.S. Pat. No. 3,573,947, herein incorporated by reference with regard to accelerators.

In some embodiments, a trimetaphosphate compound is added to the gypsum slurry used to make the core to enhance the strength of the board and to reduce the permanent deformation of the gypsum product. Gypsum compositions including polyphosphates such as trimetaphosphate compounds are disclosed in U.S. Pat. No. 6,342,284, herein incorporated by reference with regard to trimetaphosphate compounds. Exemplary trimetaphosphate salts include sodium, potassium or lithium salts of trimetaphosphate, such as those available from Astaris, LLC., St. Louis, Mo.

Thickeners can be used in some embodiments to acquire the proper rheology for making boards on a forming line. Any thickener required to sufficiently decrease the fluidity of the stucco slurry can be added to the slurry. For example, silica fume, Portland cement, fly ash, clay, cellulosic fiber, and a mixture thereof can be added to the gypsum composition. This is most advantageous for thickening slurries on a line with a line speed greater than 200 ft/minute. High molecular weight polymers, such as polyacrylamide, can also be added to the gypsum slurry to decrease the fluidity of the slurry. In some embodiments, a thickener or mixture of thickeners may be added to the slurry in less than about 10% by weight based on the weight of the stucco.

In embodiments of the invention, a foaming agent can be employed to yield voids, e.g., small air voids, in the set gypsum products. Foam may be introduced into the stucco gypsum slurry by foam pump. Alternately, liquid soap may be directly added to the stucco gypsum slurry. Many such foaming agents are well known and readily available commercially, e.g., from GEO Specialty Chemicals in Ambler, Pa. For further descriptions of useful foaming agents, see, for example: U.S. Pat. Nos. 4,676,835, 5,158,612, 5,240,639, and 5,643,510, which are, with regard to foaming agents, hereby incorporated by reference.

In many cases it will be preferred to form air voids in the gypsum product, in order to help maintain its strength. This can be accomplished by employing a foaming agent that generates foam that is relatively unstable when in contact with calcined gypsum slurry. For example, this is accomplished by blending a major amount of foaming agent known to generate relatively unstable foam, with a minor amount of foaming agent known to generate relatively stable foam.

Such a foaming agent mixture can be pre-blended “off-line”, i.e., separate from the process of preparing foamed gypsum product. However, it is preferable to blend such foaming agents concurrently and continuously, as an integral “on-line” part of the process. This can be accomplished, for example, by pumping separate streams of the different foaming agents and bringing the streams together at, or just prior to, the foam generator that is employed to generate the stream of aqueous foam which is then inserted into and mixed with the calcined gypsum slurry. By blending in this manner, the ratio of foaming agents in the blend can be simply and efficiently adjusted (for example, by changing the flow rate of one or both of the separate streams) to achieve the desired void characteristics in the foamed set gypsum product. Such adjustment will be made in response to an examination of the final product to determine whether such adjustment is needed. Further description of such “on-line” blending and adjusting can be found in U.S. Pat. No. 5,643,510, and in U.S. Pat. No. 5,683,635, which is hereby incorporated by reference with regard to foaming agents.

An example of one type of foaming agent, useful to generate unstable foams, has the formula

ROSO₃⊖M⊕ (Q)

wherein R is an alkyl group containing from 2 to 20 carbon atoms, and M is a cation. Preferably, R is an alkyl group containing from 8 to 12 carbon atoms.

An example of one type of foaming agent, useful to generate stable foams, has the formula

CH₃(CH₂)ₓCH₂(OCH₂CH₂)_{y}OSO₃⊖M⊕ (J)

wherein X is a number from 2 to 20, Y is a number from 0 to 10 and is greater than 0 in at least 50 weight percent of the foaming agent, and M is a cation.

In some preferred embodiments of the invention, foaming agents having the formulas (Q) and (J) above are blended together, such that the formula (Q) foaming agent and the portion of the formula (J) foaming agent wherein Y is 0, together constitute from 86 to 99 weight percent of the resultant blend of foaming agents.

In some preferred embodiments of the invention, the aqueous foam has been generated from a pre-blended foaming agent having the formula

CH₃(CH₂)_{X}CH₂(OCH₂CH₂)_{y}OSO₃⊖M⊕ (Z)

wherein X is a number from 2 to 20, Y is a number from 0 to 10 and is 0 in at least 50 weight percent of the foaming agent, and M is a cation. Preferably, Y is 0 in from 86 to 99 weight percent of the formula (Z) foaming agent.

Foam can be introduced into the core slurry in amounts that provide a reduced core density and panel weight. The introduction of foam in the core slurry in the proper amounts, formulations and processes can produce a desired network and distribution of air voids, and walls between the air voids, within the core of the final dried panels. In some embodiments, the air void sizes, distributions and/or wall thickness between air voids provided by the foam composition and foam introduction system are in accordance with those discussed below, as well as those that provide comparable density, strength and related properties to the panels. This air void structure permits the reduction of the gypsum and other core constituents and the core density and weight, while substantially maintaining (or in some instances improving) the panel strength properties, such as core compressive strength, and the panel rigidity, flexural strength, nail pull resistance, among others.

In some such embodiments, the mean equivalent sphere diameter of the air voids can be at least about 75 μm, and in other embodiments at least about 100 μm. In other embodiments, the mean equivalent sphere diameter of the air voids can be from about 75 μm to about 400 μm. In yet other embodiments, the mean equivalent sphere diameter of the air voids can be from about 100 μm to about 350 μm with a standard deviation from about 100 to about 225. In other embodiments, the mean equivalent sphere diameter of the air voids may be from about 125 μm to about 325 μm with a standard deviation from about 100 to about 200.

In some embodiments, from about 15% to about 70% of the air voids have an equivalent sphere diameter of about 150 μm or less. In other embodiments, from about 45% to about 95% of the air voids have an equivalent sphere diameter of about 300 μm or less, and from about 5% to about 55% of the air voids have an equivalent sphere diameter of about 300 μm or more. In other embodiments, from about 45% to about 95% of the air voids have an equivalent sphere diameter of about 300 μm or less, and from about 5% to about 55% of the air voids have an equivalent sphere diameter from about 300 μm to about 600 μm. In the discussion of average air void sizes herein, voids in the gypsum core that are about 5 μm or less are not considered when calculating the number of air voids or the average air void size.

In those and other embodiments, the thickness, distribution and arrangement of the walls between the voids in such embodiments, alone and/or in combination with a desired air void size distribution and arrangement, also permit a reduction in the panel core density and weight, while substantially maintaining (or in some instances improving) the panel strength properties. In some such embodiments, the average thickness of the walls separating the air voids may be at least about 25 μm. In some embodiments, the walls defining and separating air voids within the gypsum core may have an average thickness from about 25 μm to about 200 μm, from about 25 μm to about μm in other embodiments, and from about 25 μm to about 50 μm in still other embodiments. In yet other embodiments, the walls defining and separating air voids within the gypsum core may have an average thickness from about 25 μm to about 75 μm with a standard deviation from about 5 to about 40. In yet other embodiments, the walls defining and separating air voids within the gypsum core may have an average thickness from about 25 μm to about 50 μm with a standard deviation from about 10 to about 25.

Examples of the use of foaming agents to produce desired void and wall structures include those discussed in U.S. Pat. No. 5,643,510 and U.S. Patent Appl. No. 2007/0048490, which are hereby incorporated by reference with respect to foaming agents, voids, and wall structures. In some embodiments, a combination of a first more stable foaming agent and a second less stable foaming agent can be used in the core slurry mixture. In other embodiments, only one type of foaming agent is used, so long as the desired density and panel strength requirements are satisfied. The approaches for adding foam to a core slurry are known in the art and examples of such an approach is discussed in U.S. Pat. Nos. 5,643,510 and 5,683,635, the disclosures of which are, with regard to foaming agents, hereby incorporated by reference.

The wallboard of the present invention can have any suitable density. Board weight is a function of thickness. Since boards are commonly made at varying thickness, board density is used herein as a measure of board weight. The advantages of embodiments of the invention can be seen across various board densities, e.g., about 42 pounds per cubic foot (lbs/ft³, or pcf) or less, such as from about 15 lbs/ft³ to about 42 lbs/ft³, and from about 20 lbs/ft³ to about 37 lbs/ft³.

However, preferred embodiments of the invention have particular utility at lower densities (e.g., about 35 lbs/ft³ or less) where the enhanced fire endurance and/or compressive strength advantageously enable the use of lower weight board. For example, in some embodiments, board density can be from about 15 lbs/ft³ to about 35 lbs/ft³, e.g., about 15 lbs/ft³ to 33 lbs/ft³, about 15 lbs/ft³ to about 30 lbs/ft³, about 20 lbs/ft³ to about 35 lbs/ft³, about 20 lbs/ft³ to about 33 lbs/ft³, about 24 lbs/ft³ to about 35 lbs/ft³, about 24 lbs/ft³ to about 33 lbs/ft³, about 27 lbs/ft³ to about 35 lbs/ft³, about 27 lbs/ft³ to about 33 lbs/ft³, about 30 lbs/ft³ to about 35 lbs/ft³, and about 30 lbs/ft³ to about 33 lbs/ft³.

In embodiments of the invention, the board density can be, e.g., as listed in Tables 6A and 6B. In the tables, an “X” represents the range “from about [corresponding value in top row] to about [corresponding value in left-most column].” The indicated values represent the board density in lb/ft³ (Tables 6A and 6B). For ease of presentation, it will be understood that each value represents “about” that value. For example, the first “X” in Table 6A is the range “from about 15 lbs/ft³ to about 16 lbs/ft³.” The ranges of the tables are between and including the starting and endpoints.

TABLE 6A

| | | Starting Point for Board Density (lbs/ft³) | | | | | | | | | | | |
|---|---|---|---|---|---|---|---|---|---|---|---|---|---|
| | | 15 | 16 | 17 | 18 | 19 | 20 | 21 | 22 | 23 | 24 | 25 | 26 |
| End Point | 16 | X | | | | | | | | | | | |
| for | 17 | X | X | | | | | | | | | | |
| Board | 18 | X | X | X | | | | | | | | | |
| Density | 19 | X | X | X | X | | | | | | | | |
| (lbs/ft³) | 20 | X | X | X | X | X | | | | | | | |
| | 21 | X | X | X | X | X | X | | | | | | |
| | 22 | X | X | X | X | X | X | X | | | | | |
| | 23 | X | X | X | X | X | X | X | X | | | | |
| | 24 | X | X | X | X | X | X | X | X | X | | | |
| | 25 | X | X | X | X | X | X | X | X | X | X | | |
| | 26 | X | X | X | X | X | X | X | X | X | X | X | |
| | 27 | X | X | X | X | X | X | X | X | X | X | X | X |
| | 28 | X | X | X | X | X | X | X | X | X | X | X | X |
| | 29 | X | X | X | X | X | X | X | X | X | X | X | X |
| | 30 | X | X | X | X | X | X | X | X | X | X | X | X |
| | 31 | X | X | X | X | X | X | X | X | X | X | X | X |
| | 32 | X | X | X | X | X | X | X | X | X | X | X | X |
| | 33 | X | X | X | X | X | X | X | X | X | X | X | X |
| | 34 | X | X | X | X | X | X | X | X | X | X | X | X |
| | 35 | X | X | X | X | X | X | X | X | X | X | X | X |
| | 36 | X | X | X | X | X | X | X | X | X | X | X | X |
| | 37 | X | X | X | X | X | X | X | X | X | X | X | X |
| | 38 | X | X | X | X | X | X | X | X | X | X | X | X |
| | 39 | X | X | X | X | X | X | X | X | X | X | X | X |
| | 40 | X | X | X | X | X | X | X | X | X | X | X | X |
| | 41 | X | X | X | X | X | X | X | X | X | X | X | X |
| | 42 | X | X | X | X | X | X | X | X | X | X | X | X |

TABLE 6B

| | | Starting Point for Board Density (lbs/ft³) | | | | | | | | | | | | | | |
|---|---|---|---|---|---|---|---|---|---|---|---|---|---|---|---|---|
| | | 27 | 28 | 29 | 30 | 31 | 32 | 33 | 34 | 35 | 36 | 37 | 38 | 39 | 40 | 41 |
| End Point | 28 | X | | | | | | | | | | | | | | |
| for | 29 | X | X | | | | | | | | | | | | | |
| Board | 30 | X | X | X | | | | | | | | | | | | |
| Density | 31 | X | X | X | X | | | | | | | | | | | |
| (lbs/ft³) | 32 | X | X | X | X | X | | | | | | | | | | |
| | 33 | X | X | X | X | X | X | | | | | | | | | |
| | 34 | X | X | X | X | X | X | X | | | | | | | | |
| | 35 | X | X | X | X | X | X | X | X | | | | | | | |
| | 36 | X | X | X | X | X | X | X | X | X | | | | | | |
| | 37 | X | X | X | X | X | X | X | X | X | X | | | | | |
| | 38 | X | X | X | X | X | X | X | X | X | X | X | | | | |
| | 39 | X | X | X | X | X | X | X | X | X | X | X | X | | | |
| | 40 | X | X | X | X | X | X | X | X | X | X | X | X | X | | |
| | 41 | X | X | X | X | X | X | X | X | X | X | X | X | X | X | |
| | 42 | X | X | X | X | X | X | X | X | X | X | X | X | X | X | X |

A low basis weight can be achieved by mixing stucco slurry with a predetermined amount of foam based upon the target basis weight of the wallboard. As the board contains less gypsum per unit volume, there is less crystallized water available for fire endurance of the wallboard. In addition, during exposure to a fire, the percent shrinkage can increase as the board density decreases. Both factors make it increasingly difficult to pass a fire test. Surprisingly and unexpectedly, the inclusion of metal silicate in embodiments of the invention allow for the preparation of low density, as described herein, final product with fire endurance property.

A wallboard of any thickness can be produced using the presently described methods and systems. The typical thickness of gypsum boards is ½ inch and % inch, but may range from ¼ inch to 1 inch. In some embodiments, the wallboard can have a thickness from about 0.25 inch to about 1 inch. In embodiments of the invention, the wallboard thickness can be, e.g., as listed in Table 7. In the table, an “X” represents the range “from about [corresponding value in top row] to about [corresponding value in left-most column].” The indicated values represent the thickness of a board in inches (Table 7). For ease of presentation, it will be understood that each value represents “about” that value. For example, the first “X” in Table 7 is the range “from about 0.59 inches to about 0.6 inches.” The ranges of the table are between and including the starting and endpoints.

TABLE 7

| | | Starting Point for | | | | | |
|---|---|---|---|---|---|---|---|
| | | Wallboard Thickness (inches) | | | | | |
| | | 0.59 | 0.6 | 0.61 | 0.62 | 0.63 | 0.64 |
| End Point for Wallboard | 0.6 | X | | | | | |
| Thickness (inches) | 0.61 | X | X | | | | |
| | 0.62 | X | X | X | | | |
| | 0.63 | X | X | X | X | | |
| | 0.64 | X | X | X | X | X | |
| | 0.65 | X | X | X | X | X | X |

The present invention can provide high fire endurance for lightweight gypsum board. In preferred embodiments, the board, at a thickness of about ⅝ inch, has a basis weight of less than about 2000 lbs/1000 ft². In other preferred embodiments, the board, at a thickness of about ⅝ inch, has a basis weight of less than about 1800 lbs/1000 ft². However, the wallboard of the present invention may be of any basis weight. In embodiments of the invention, the basis weight of the wallboard can be, e.g., as listed in Table 8. In the table, an “X” represents the range “from about [corresponding value in top row] to about [corresponding value in left-most column].” The indicated values represent the basis weight of board in lbs/1000 ft² (Table 8). For ease of presentation, it will be understood that each value represents “about” that value. For example, the first “X” in Table 8 is the range “from about 1200 lbs/1000 ft² to about 1300 lbs/1000 ft².” The ranges of the table are between and including the starting and endpoints.

TABLE 8

| | | Starting Point for Board | | | | | | | |
|---|---|---|---|---|---|---|---|---|---|
| | | Basis Weight Range (lb/1000 ft²) | | | | | | | |
| | | 1200 | 1300 | 1400 | 1500 | 1600 | 1700 | 1800 | 1900 |
| End | 1300 | X | | | | | | | |
| Point | 1400 | X | X | | | | | | |
| for | 1500 | X | X | X | | | | | |
| Board | 1600 | X | X | X | X | | | | |
| Basis | 1700 | X | X | X | X | X | | | |
| Weight | 1800 | X | X | X | X | X | X | | |
| Range | 1900 | X | X | X | X | X | X | X | |
| (lb/1000 | 2000 | X | X | X | X | X | X | X | X |
| ft²) | | | | | | | | | |

Paper sheets, such as Manila paper or kraft paper, can be used as the cover sheets. Useful cover sheet paper includes Manila 7-ply and News-Line 5-ply; Grey-Back 3-ply and Manila Ivory 3-ply; and Manila heavy paper and MH Manila HT (high tensile) paper. An exemplary back cover sheet paper is 5-ply newsline. In addition, the cellulosic paper can comprise any other material or combination of materials. For example, the cover sheets may comprise glass fibers, ceramic fibers, mineral wool, or a combination of the aforementioned materials.

In other embodiments, the cover sheet can comprise, consist essentially of, or consist of a mat, such as an unwoven fiberglass mat, sheet materials of other fibrous or non-fibrous materials, or combinations of paper and other fibrous materials maybe used as one or both of the cover sheets. As used herein, the term “mat” includes mesh materials. Fibrous mats can include any suitable fibrous mat material. For example, in some embodiments, the cover sheet can be a mat made from glass fiber, polymer fiber, mineral fiber, organic fiber, or the like or combinations thereof. Polymer fibers include, but are not limited to, polyamide fibers, polyaramide fibers, polypropylene fibers, polyester fibers (e.g., polyethylene teraphthalate (PET)), polyvinyl alcohol (PVOH), and polyvinyl acetate (PVAc). Examples of organic fibers include cotton, rayon, and the like. The fibers of the mat can be coated or uncoated. Selecting a suitable type of fibrous mat will depend, in part, on the type of application in which the board is used.

In some embodiments, a gypsum board comprising a heavy newsline sheet has greater fire endurance. In some embodiments, a gypsum board comprises a set gypsum composition disposed between first and second cover sheets. The set gypsum composition comprises an interlocking matrix of set gypsum formed from a slurry comprising at least stucco, water, and metal silicate. At least one of the cover sheets has a basis weight greater than about 50 lbs/1000 ft². In another embodiment, at least one of the cover sheets has a basis weight greater than about 55 lbs/1000 ft². In yet another embodiment, at least one of the cover sheets has a basis weight greater than about 60 lbs/1000 ft².

In an embodiment, the present invention provides a gypsum board which comprises a set gypsum composition disposed between first and second cover sheets. The set gypsum composition comprises an interlocking matrix of set gypsum formed from a slurry comprising at least stucco, water, and metal silicate. The gypsum board comprises silica gel, has a density from about 15 lbs/ft³ to about 42 lbs/ft³, and a dry weight of less than about 2000 lbs/1000 ft² when at a thickness of about % inch. The second cover sheet (e.g., back cover sheet) has a thickness greater than about 0.014 inches, and a thermal conductivity of about 0.1 w/(m.k.) or less. When the board is disposed in a Fire Endurance Index test apparatus and the second cover sheet (e.g., back cover sheet) faces the door of the testing apparatus, the FEI of the board is greater than about 50 minutes.

In an embodiment, gypsum board is formed from a slurry comprising stucco, water, and metal silicate. The slurry can be kneaded using a commonly used pin mixer, as known in the art. The slurry is disposed between two cover sheets, cut into a board of predetermined dimensions after the slurry has hardened sufficiently for cutting, and dried. The board comprises silica gel in an amount greater than the amount of metal silicate in the board and has a density from about 15 lbs/ft³ to about 42 lbs/ft³, and a Fire Endurance Index (FEI) greater than about 53 minutes. In some embodiments, a metal silicate solution having a pH from about 5 to about 10 is added to the slurry. The metal silicate solution having a pH from about 5 to about 10 may be obtained by treatment of the solution with sulfuric acid. In some embodiments, the metal silicate solution has a concentration from about 0.1% to about 10%.

Joint compound formulations can comprise silica gel, including both dry and ready-mix embodiments. In some embodiments, the joint compound is formed from at least calcium carbonate and metal silicate. The metal silicate can convert to silica gel in situ. In another embodiment, the joint compound further comprises calcined gypsum. In another embodiment, the joint compound further comprises water and set retarder. To inhibit premature setting in some ready-mix embodiments, set retardant is also desirably included in some embodiments as one of ordinary skill in the art will appreciate. For example, U.S. Pat. Nos. 4,661,161; 5,746,822; and U.S. Patent Application Publication 2011/0100844 describe set retarders (e.g., phosphate such as tetra sodium pyrophosphate (TSPP), polyacrylic acid and/or salt thereof, or the like), and other ingredients (e.g., latex emulsion binder, thickener, phosphate as described herein, and the like, or combinations thereof). that may be useful in accordance with the present invention, which is incorporated by reference herein with regard to set retarders. Other ingredients and methods of making and using joint compound are discussed in, e.g., U.S. Pat. Nos. 6,406,537 and 6,805,741; as well as U.S. Patent Application Publication 2008/0305252, which are incorporated by reference herein with regard to joint compound.

Metal silicates according to embodiments of the invention also can be used with various types of acoustical panels (e.g., ceiling tile). In some embodiments, the metal silicate can be mixed with calcined gypsum, water, and other ingredients as desired. The metal silicate converts to silica gel. In some embodiments, the acoustical panel also comprises fibers, such as mineral wool. In some embodiments, the panel has a Noise Reduction Coefficient of at least about 0.5 (e.g., at least about 0.7 or at least about 1) according to ASTM C 423-02. See, e.g., U.S. Pat. Nos. 1,769,519; 6,443,258; 7,364,015; 7,851,057; and 7,862,687 for discussion of ingredients and methods for making acoustical tile, which is incorporated by reference herein with regard to acoustical tile.

In some embodiments, assemblies can be constructed, using gypsum boards formed according to principles of the present invention, that conform to the specification of Underwriters Laboratories, Inc. (UL®) assemblies, such as U419, U305, and U423. The face of one side of the assembly can be exposed to increasing temperatures for a period of time in accordance with a heating curve, such as those discussed in the ASTM E119 (e.g., ASTM E119-09a) procedures. The temperatures proximate the heated side and the temperatures at the surface of the unheated side of the assembly are monitored during the tests to evaluate the temperatures experienced by the exposed gypsum panels and the heat transmitted through the assembly to the unexposed panels. One useful indicator of the fire performance of gypsum panels in assemblies, for example those utilizing loaded, wood stud frames as called for in the ASTM E119 fire tests, is discussed in the article Shipp, P. H., and Yu, Q., “Thermophysical Characterization of Type X Special Fire Resistant Gypsum Board,” Proceedings of the Fire and Materials 2011 Conference, San Francisco, 31 Jan.-2 Feb. 2011, Interscience Communications Ltd., London, UK, pp. 417-426. The article discusses an extensive series of E119 fire tests of load bearing wood framed wall assemblies and their expected performance under the E119 fire test procedures. U.S. Pat. No. 8,323,785 is incorporated by reference herein with regard to ASTM E119.

In some embodiments, an assembly of gypsum boards formed according to principles of the present invention and in accordance with the specification of a U419 assembly, with or without cavity insulation, has a fire rating of at least about 60 minutes when heated in accordance with the time-temperature curve of ASTM standard E119-09. In some embodiments, an assembly of gypsum boards formed according to principles of the present invention and in accordance with the specification of a U305 assembly has a fire rating of at least about 55 minutes when heated in accordance with the time-temperature curve of ASTM standard E119-09. In some embodiments, an assembly of gypsum boards formed according to principles of the present invention and in accordance with the specification of a U305 assembly has a fire rating of at least about 60 minutes when heated in accordance with the time-temperature curve of ASTM standard E119-09. In some embodiments, an assembly of gypsum boards formed according to principles of the present invention and in accordance with the specification of a U423 assembly has a fire rating of at least about 60 minutes when heated in accordance with the time-temperature curve of ASTM standard E119-09.

In addition to common testing methods, the utility of the present invention to increase fire endurance can be analyzed using a small-scale FEI test. The FEI test is a small scale testing apparatus and method developed as an alternative to typical large scale wallboard testing. Fire endurance ratings are typically obtained by performing a full-size (at 100 ft² of wall area) fire test in a certified fire test laboratory per ASTM standards, which is time-consuming, expensive, and unsuitable for bench-top studies and quality control.

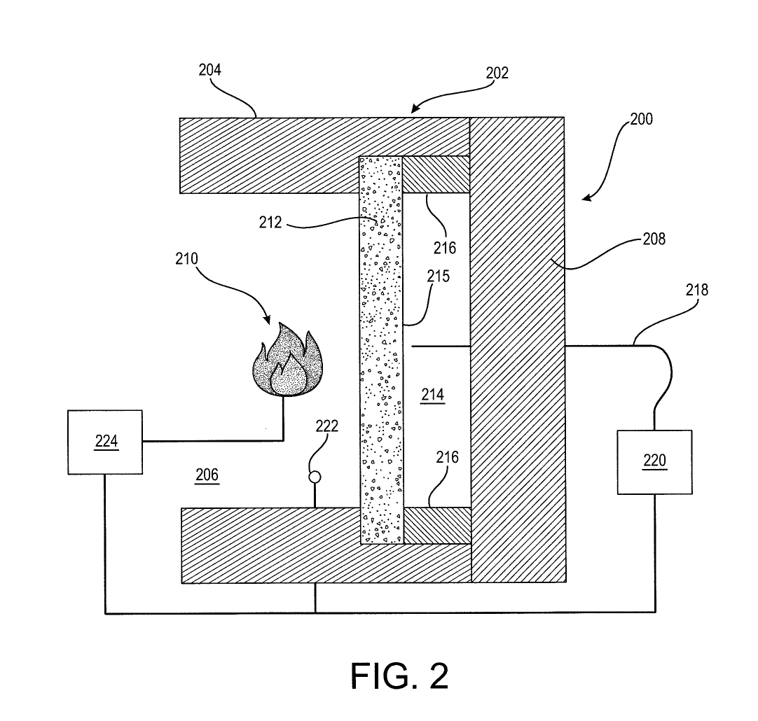

A schematic diagram of a testing system 200 is shown, in cross section, in FIG. 2. The testing system 200 includes a muffle furnace 202 having an enclosure 204 forming a furnace chamber 206. The chamber 206 is closeable with a door 208 and includes a heat source 210 therewithin. The heat source 210 may be any known type of heat source such as a fuel-fired combustor or an electric-resistive heater, which operates to create a generally uniformly distributed temperature profile within the chamber 206.

In the illustration of FIG. 2, a board sample 212 is shown disposed within the furnace chamber 206 during a test. The sample 212 is mounted vertically within the chamber 206 in the illustrated embodiment at an offset distance from a door opening such that a gap 214 is formed between a back face 215 of the sample 212 and an oven-facing side of the door 208. Spacers 216 are disposed at a distance from one another between the sample 212 and the door 208 to simulate studs that space apart wallboards in a finished wall assembly. Although the gap 214 is shown empty, in an alternative embodiment the gap 214 may be filled with a wall-insulation material. Moreover, metal or wooden studs may be used in place of the spacers 216. The spacers may be connected to the sample 212 and, in certain embodiments, may be subjected to a compressive load along with the sample 212 to simulate a load-bearing wall.

A thermocouple 218 or other temperature-sensing device is connected close to the back face 215 of the sample during testing. The back face 215 can be thicker than the front face of the sample. The thermocouple 218 has a sensing tip at a small distance from the surface of the sample 212. In alternative embodiments, the sending tip can touch or be within the sample 212. The thermocouple 218 is configured to sense a surface temperature or a temperature near the surface of the back face of the sample 212 during testing. The thermocouple 218 is connected to a data acquisition unit 220, which operates to provide power to the thermocouple 218, receive information therefrom indicative of the surface temperature of the sample 212, record the temperature information and, optionally or with the aid of a computer (not shown), plot the temperature information over time or otherwise analyze the information numerically.

When a test is conducted, the temperature of the muffle furnace chamber 206 is gradually increased over time by appropriately controlling the intensity of the heat source 210. In one embodiment, a furnace temperature sensor 222 is disposed to measure the temperature of the furnace chamber 206, provide information indicative of the furnace chamber temperature to a heater controller 224 and, optionally, also to the data acquisition unit 220. The heater controller 224 may operate in a closed loop fashion based on the information provided by the sensor 222 to provide a predetermined heating profile for the chamber 206 by appropriately and automatically adjusting the intensity of the heat source 210. The temperature rise of the chamber 206 may also optionally be recorded by the data acquisition unit 220 for establishing testing integrity.

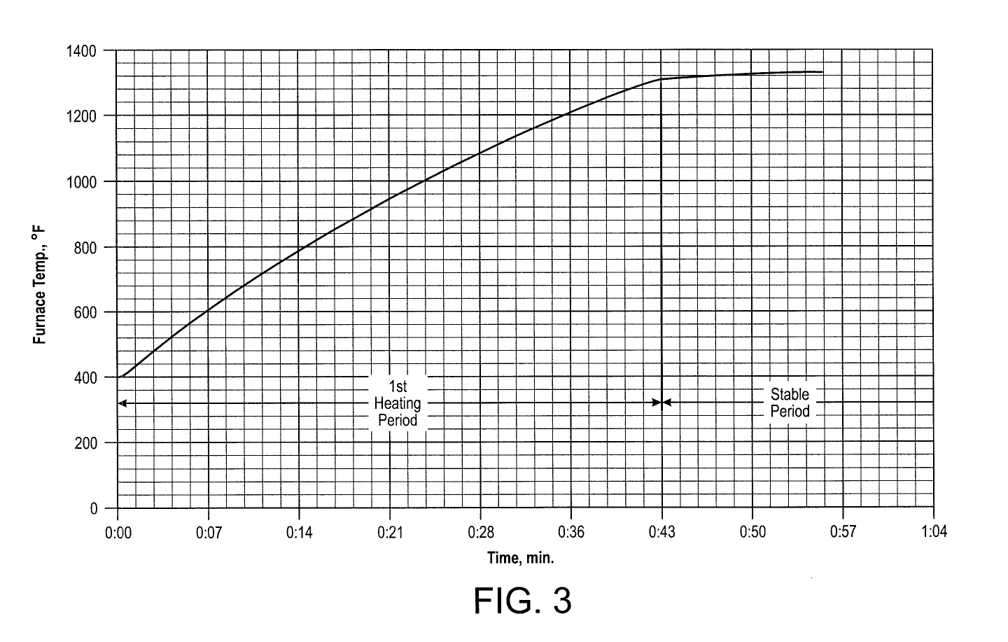

A sample heating profile of the furnace chamber is shown in the time plot of FIG. 3. As can be seen from the plot, where a desired chamber temperature (deg. F.) is plotted along the vertical axis and time (min.) is plotted along the horizontal axis, the chamber 206 is heated gradually following a logarithmic trend for about the first 43 minutes of the test from a temperature of about 400° F. (204° C.) to a temperature of about 1,423° F. (773° C.), and is maintained at that temperature for the remainder of the test, which in the illustrated graph continues for about 1 hour. Thus, the test is conducted over a first, heating period 226, and then continues over a stable period 228, as marked on the chart of FIG. 3.

It has been determined that heat transfer through the sample 212 during a test, as gleaned by the measured surface temperature on the back face 215 of the sample, is concomitant to and indicative of the expected heat transfer through a wallboard in a full scale fire test. In essence, the test describes herein determines the rate of heat transfer through the sample. In one embodiment, temperature readings taken on both sides of the board can be used to estimate, in real time, the heat transfer rate through the board. By comparing the heat transfer curves of different products and correlating the curves to their actual fire test results, judgment and prediction of the performance of fire endurance of different products are advantageously enabled. In the test setup shown in FIG. 2, sample dimension was selected to be a rectangular sample having dimensions of 6.125″×6.625″ and a thickness of 0.625″. The depth of the cavity 214 was ⅞″, and the thermocouple 218 was located in the geometrical center of the door 208, where the sensing probe of the thermocouple 218 protruded about 11/16″ from the inside surface of the door 208 in the direction of the sample 212. In this way, the tip of the thermocouple was 3/16″ away from the surface of the sample. A glass wool frame was placed against the sample to act as the spacer 216 and keep the sample in place while also sealing the door frame against heat leakage. For half-inch thick samples, a metal frame of 0.125″ thickness can be placed behind the sample to maintain the gap between the thermocouple and the sample and preserve the remaining test setup. The controller 224 of the muffle furnace was set to run from 200° C. to 773° C. The actual temperature curve of the muffle furnace at the front end is shown in FIG. 3.

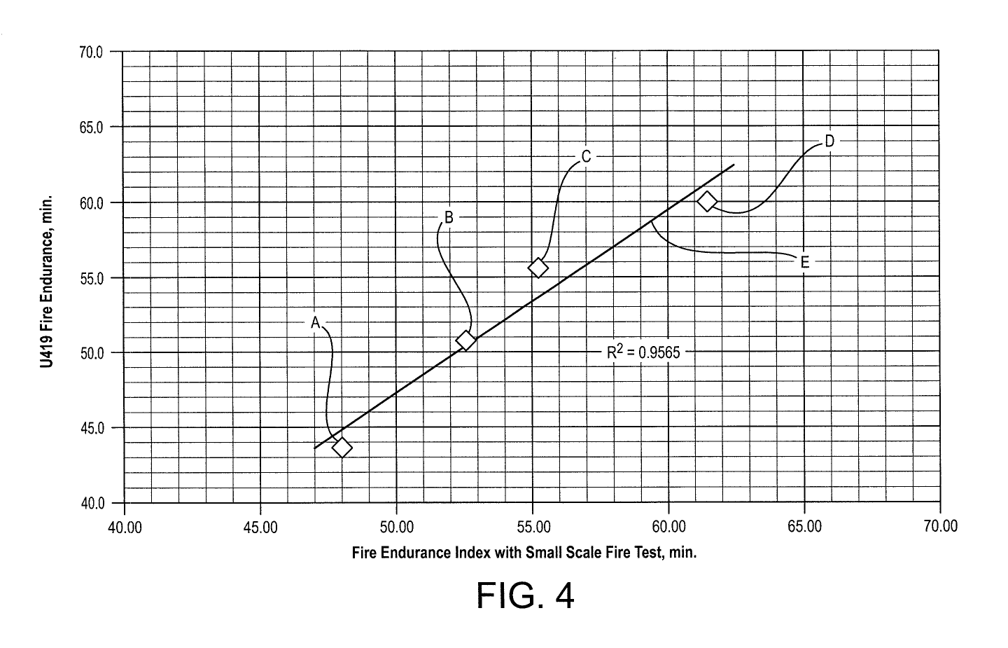

The test provides a temperature-time curve for a specific board sample. FEI can be determined from the curve. Fire endurance index is defined as the time required to reach 600° F. (315.5° C.) at the backside of a test specimen in the small scale fire test. Data points A, B, C, and D are plotted, and the correlation between FEI and fire endurance time from U419 full-size fire test is shown in FIG. 4. Other designs of fire test assembly such as U305 and U423 can be extrapolated from FEI as well.

In some embodiments, the gypsum board has a FEI of at least about 2 minutes greater than a board comprising set gypsum having no silica gel. In some embodiments, the gypsum board has a FEI of at least about 3 minutes greater than a board comprising set gypsum having no silica gel. In some embodiments, the gypsum board has a FEI of at least about 4 minutes greater than a board comprising set gypsum having no silica gel. In some embodiments, the gypsum board has a FEI of at least about 5 minutes greater than a board comprising set gypsum having no silica gel. In some embodiments, the gypsum board has a FEI of at least about 6 minutes greater than a board comprising set gypsum having no silica gel. In some embodiments, the gypsum board has a FEI of at least about 7 minutes greater than a board comprising set gypsum having no silica gel. In some embodiments, the gypsum board has a FEI of at least about 8 minutes greater than a board comprising set gypsum having no silica gel. In some embodiments, the gypsum board has a FEI of at least about 9 minutes greater than a board comprising set gypsum having no silica gel. In some embodiments, the gypsum board has a FEI of at least about 10 minutes greater than a board comprising set gypsum having no silica gel.

Thus, in an embodiment, a gypsum board comprises a set gypsum composition disposed between two cover sheets, the set gypsum composition comprising an interlocking matrix of set gypsum formed from a slurry comprising at least stucco, water, and metal silicate, wherein the set gypsum composition comprises silica gel in an amount greater than the amount of metal silicate in the set gypsum composition and the gypsum board has a density from about 15 lbs/ft³ to about 42 lbs/ft³ and a FEI greater than about 53 minutes.

In an embodiment, a gypsum board comprises a set gypsum composition disposed between two cover sheets, the set gypsum composition comprising an interlocking matrix of set gypsum formed from a slurry comprising at least stucco, water, and metal silicate, wherein the set gypsum composition comprises silica gel, and the gypsum board has a density from about 15 lbs/ft³ to about 42 lbs/ft³ and a FEI greater than about 53 minutes.

In another embodiment, the metal silicate is sodium silicate, potassium silicate, lithium silicate, or a combination thereof.

In another embodiment, the metal silicate (in an active basis) is in an amount from about 0.01% to about 5% by weight based on the weight of stucco.

In another embodiment, the metal silicate (in an active basis) is in an amount from about 0.01% to about 1% by weight based on the weight of stucco.

In another embodiment, prior to addition to the slurry, the metal silicate is included in a solution having a pH from about 5 to about 10.

In another embodiment, prior to addition to the slurry, the metal silicate is included in a solution having a pH from about 5 to about 7.

In another embodiment, the metal silicate has a SiO₂ to metal oxide ratio from about 0.5 to about 5.0.

In another embodiment, the metal silicate has a SiO₂ to metal oxide ratio from about 2 to about 4.

In another embodiment, the set gypsum composition comprises vermiculite in an amount less than about 5% by weight based on the weight of the stucco.

In another embodiment, the gypsum board has a silica gel to metal silicate weight ratio from about 1 to 1 to about 99 to 1.

In another embodiment, the board has a silica gel to metal silicate weight ratio greater than about 99 to 1.

In another embodiment, the board has a silica gel to metal silicate weight ratio greater than about 90 to 10.

In another embodiment, the board has a silica gel to metal silicate weight ratio greater than about 1 to 1.

In another embodiment, the board has a density from about 15 lbs/ft³ to about 35 lbs/ft³.

In another embodiment, the board has a density from about 15 lbs/ft³ to about 33 lbs/ft³.

In another embodiment, the board has a dry weight of less than about 2000 lbs/1000 ft² when at a thickness of about % inch.

In another embodiment, the silica gel is in an amount effective to increase the compressive strength of the gypsum board relative to the compressive strength of a gypsum board without the silica gel.

In another embodiment, the gypsum board has a FEI of at least about 3 minutes greater than a board comprising set gypsum having no silica gel.

In another embodiment, the board is built into a test assembly in accordance with UL U305, the board has a fire rating of at least about 55 minutes when heated in accordance with the time-temperature curve of ASTM standard E119-09.

In another embodiment, the board is built into a test assembly in accordance to UL U305, and has a fire rating of at least about 60 minutes when heated in accordance with the time-temperature curve of ASTM standard E119-09.

In another embodiment, the board is built into a test assembly in accordance with UL U419, the board has a fire rating of at least about 60 minutes when heated in accordance with the time-temperature curve of ASTM standard E119-09.

In another embodiment, the gypsum board has a thickness from about 0.59 inches to about 0.65 inches.

In another embodiment, the slurry has a water-to-stucco ratio from about 1.0 to about 2.0.

In another embodiment, the slurry has a water-to-stucco ratio from about 1.2 to about 2.0.

In another embodiment, at least one of the two cover sheets has a basis weight greater than about 60 lbs/1000 ft².

In an embodiment, a method for making a gypsum board comprises forming a slurry comprising stucco, water, and metal silicate, disposing the slurry between two cover sheets, cutting the board preform into a board of predetermined dimensions after the slurry has hardened sufficiently for cutting, and drying the board, wherein the board comprises silica gel, has a density from about 15 lbs/ft³ to about 42 lbs/ft³, and has a FEI greater than about 53 minutes.

In an embodiment, a method of increasing fire endurance of a gypsum board comprising forming a slurry comprising stucco, water, and metal silicate, disposing the slurry between two cover sheets to form a board preform, cutting the board preform into a gypsum board of predetermined dimensions after the slurry has hardened sufficiently for cutting, and drying the gypsum board; wherein at least a portion of the metal silicate converts to silica gel and the gypsum board has increased fire endurance as compared to a board having no silica gel, a density from about 15 lbs/ft³ to about 42 lbs/ft³, and a Fire Endurance Index greater than about 53 minutes.

In another embodiment, the method further comprises including the metal silicate in a solution having a pH of about 5 to about 10 prior to forming the slurry.

In another embodiment, the metal silicate solution was neutralized to a pH from about 5 to about 10 using sulfuric acid.

In another embodiment, the metal silicate is in a solution and has a pH from about 5 to about 10.

In another embodiment, the slurry comprises a metal silicate solution having a pH from about 5 to about 10.

In another embodiment, the metal silicate solution has a concentration from about 0.1% to about 10%.

In another embodiment, the metal silicate solution has a concentration from about 3% to about 4%.

In an embodiment, an acoustical panel comprises an acoustical component comprising silica gel, wherein the panel has a Noise Reduction Coefficient of at least about 0.5 according to ASTM C 423-02.

In another embodiment, the acoustical panel further comprises fibers.

In an embodiment, a joint compound comprises calcium carbonate and silica gel.

In another embodiment, the joint compound further comprises calcined gypsum.

In another embodiment, the joint compound further comprises water and set retarder.

It shall be noted that the preceding are merely examples of embodiments. Other exemplary embodiments are apparent from the entirety of the description herein. It will also be understood by one of ordinary skill in the art that each of these embodiments may be used in various combinations with the other embodiments provided herein.

The following examples further illustrate the invention but, of course, should not be construed as in any way limiting its scope.

### Example 1

### Method for Neutralizing Silicates

This Example demonstrates a practical method for neutralizing silicates. Accordingly, concentrated sodium silicate (PQ Corp's N®, concentration=37.5%, SiO₂/Na₂O=3.22) was treated using the conditions disclosed in Table 9.

Sodium silicate solutions were diluted with water and treated with either HCl (20%) or H₂SO₄ (98%). It was observed that gel formation was dependent upon silicate concentration, the pH of the solution, and the type of acid used. The most practical conditions for board manufacture were obtained when the silicate solution was diluted to a concentration of 3.2%, and dosed with H₂SO₄ (98%, 1.4 g) until a pH of 6.73 was reached (see Table 9, Test No. 4). Under these conditions, the silicate solution formed a gel in 2 hours.

TABLE 9
Neutralization of Sodium Silicate Under Different Conditions

| | | | | Acid | | |
|---|---|---|---|---|---|---|
| | Silicate as | Water | | (conc.)/ | | |
| Test | Received | Added | Conc. | amount | | |
| No. | (g) | (g) | (%) | (g) | pH | Observation |
| 1 | 10.44 | 16.3 | 39.0 | HCl | <7 | Powderous |
| | | | | (20%)/ | | precipitates were |
| | | | | 1.95 | | formed right way. |
| 2 | 10.00 | 100.0 | 9.1 | HCl | 6.75 | A gel formed right |
| | | | | (20%)/ | | away. |
| | | | | 4.94 | | |
| 3 | 10.01 | 305.0 | 3.2 | HCl | 6.92 | A cloudy solution |
| | | | | (20%)/ | | (sol) was formed |
| | | | | 5.05 | | right way; |
| | | | | | | overnight, a gel was |
| | | | | | | formed. |
| 4 | 10.00 | 300.0 | 3.2 | H₂SO₄ | 6.73 | Formed gel in two |
| | | | | (98%)/ | | hours |
| | | | | 1.4 | | |

### Example 2

### Effect of Silicate on Fire Endurance

This Example demonstrates the effect of silicate addition on fire endurance of a wallboard. Accordingly, five gypsum boards (samples 1-5) were made with active silicate amounts ranging from 0% to 0.90% by weight based on the weight of stucco. In addition, a constant water-to-stucco ratio of 1.0 and a variable amount of foam were used to obtain the desired board weight.

In a laboratory, a 3% silicate solution was prepared by mixing 30 grams of sodium silicate (PQ Corp's N®, 37.5% concentration, pH 11.3, SiO₂/Na₂O=3.22) and 1000 mL tap water. The solution was adjusted to a pH of about 5.8. The solution was freshly prepared to make each board. To individual steel bowls was added 0 g silicate solution (sample 1), 150 g silicate solution (sample 2), 300 g silicate solution (sample 3), 600 g silicate solution (sample 4), and 900 g silicate solution (sample 5). Additional tap water was added to the bowls for samples 1-4 to reach a total weight of 900 g. To the water was added 2-3 drops of retarder (Dow Chemical, Versenex 90) and 0.5 g dispersant (GEO Specialty Chemicals, Diloflo Calif.). In five separate bowls was mixed 900 g of stucco, 5.2 g of chopped fiberglass (Owens Corning, Advantex 790C-16W), 34.6 g of vermiculite (Virginia Vermiculite, grade 4), 15.1 g of pregelatinized starch (Bunge Milling, USG-95), 2.3 g of accelerator (USG, ground gypsum), and 1.0 g sodium trimetaphosphate (Innophos). Each stucco mixture was poured into the steel bowl containing the silicate/retarder/dispersant mixture, which was installed under a Hobart mixer. The mixture was immediately mixed and injected with foam. After 25 seconds, foam injection was stopped and the stucco slurry was mixed for another 5 seconds. The stucco slurry was then immediately poured into a premade paper envelop (with 50 lbs/1000 ft² manila and 40 lbs/1000 ft² newsline, 1 ft×1 ft). The envelope containing the stucco slurry was sandwiched between two aluminum plates that were spaced to make ⅝ inch boards. The gypsum was allowed to set. The boards were placed into an oven preset at 350° F. (177° C.) for 30 minutes, and then the boards were transferred to another oven preset at 110° F. (43° C.). The boards were dried in the oven for two nights. The dried boards were cut into sizes of 6.625 inches×6.125 inches boards.

TABLE 10
Additives

ADVANTEX ® 790C-16W continuous glass strands (Owens
Corning, Toledo, OH)
Vermiculite Concentrate Grade 4 (Virginia Vermiculite, Louisa, VA)
Diloflo Dispersant (Polynaphthalene Sulfonate, Geo Specialty
Chemicals, Cleveland, OH)
Climate Stabilized Accelerator (CSA), Pre-Mix
Pregelatinized Starch, Corn Flour (Yellow)
(Bunge Milling, St. Louis, MO)
Sodium trimetaphosphate (Innophos, Cranberry, NJ)
Hyonic PFM 33 (Stable soap), Hyonic 25-AS (Unstable soap)
(Geo Specialty Chemicals, Inc., Cedartown, GA)
VERSENEX ™ 80 Chelating Agent Retarder
(Diethylenetriaminepentaacetic Acid, Pentasodium Salt)

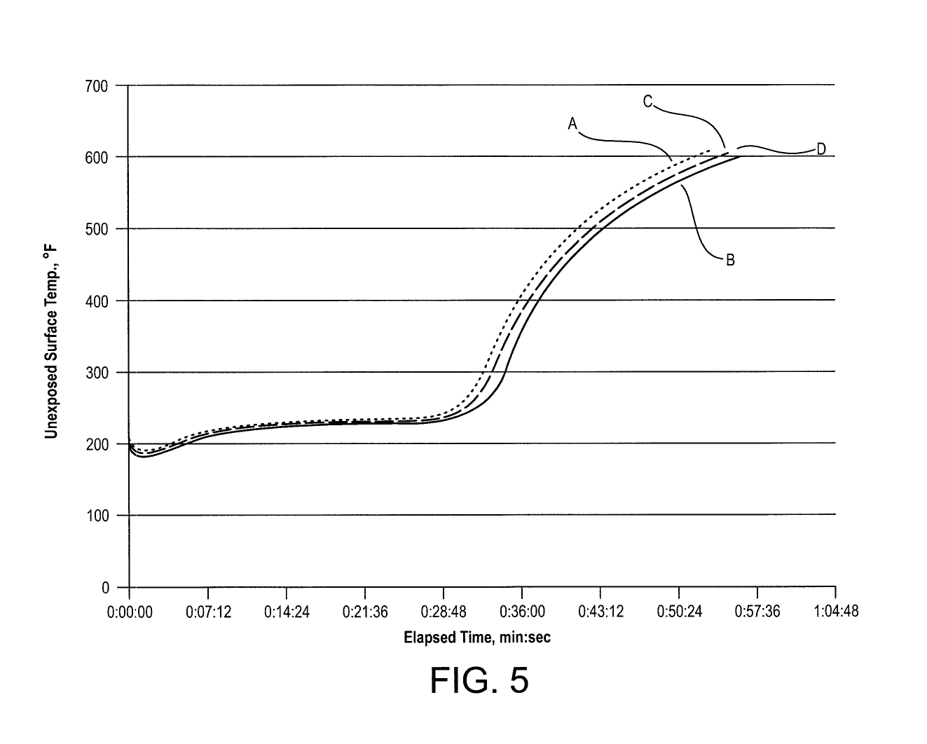

Samples 1-5 were individually tested in the small-scale device (FIG. 2) to determine their respective FEI. Temperature traces for four of the samples are shown in FIG. 5, where time is plotted along the horizontal axis and the unexposed surface temperature of the back-face of each sample is plotted along the vertical axis. In the graph of FIG. 5, line A represents the temperature trace for the control board (sample 1), line B represents the temperature trace for a board formed from a slurry having 0.15% active sodium silicate (sample 2), line C represents the temperature trace for a board formed from a slurry having 0.30% active sodium silicate (sample 3), and line D represents the temperature trace for a board formed from a slurry having 0.60% active sodium silicate (sample 4). Since the board weight for sample 5 was too high, this data was not included in FIG. 5.

As can be calculated from the graph of FIG. 5, the Fire Endurance Index of the control board was 52.2 minutes (sample 1), 55.8 minutes for the board formed from a slurry having 0.15% active sodium silicate (sample 2), 54.7 minutes for the board formed from a slurry having 0.30% active sodium silicate (sample 3), 54.6 minutes for the board formed from a slurry having 0.60% active sodium silicate (sample 4). The FEI was 55.2 minutes for the board formed from a slurry having 0.90% active sodium silicate (Table 11, sample 5).

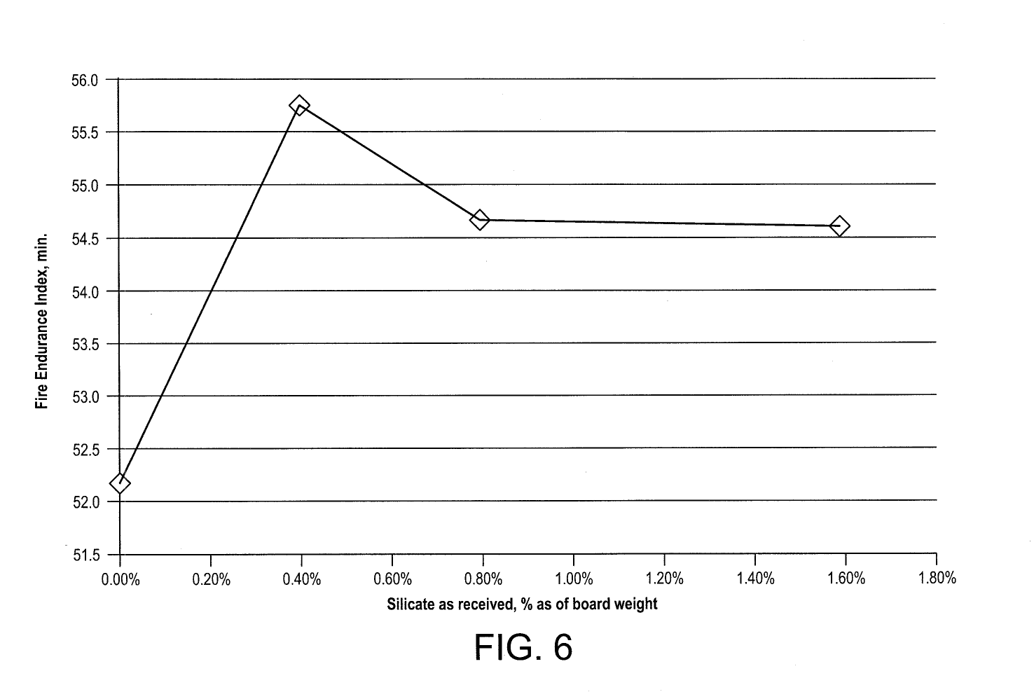

As shown in Table 11, the amount of silicate does not significantly affect shrinkage in the presence of vermiculite. When compared to the control, the board formed from a slurry comprising 0.40% silicate as received (i.e., 0.15% active silicate) increased the FEI by 3.6 minutes. FIG. 6 suggests that the FEI may peak with an active silicate content of 0.15%. The percentage of silicate as received represents the metal silicate solution by weight based on the weight of stucco, while the percentage of active silicate represents the metal silicate by weight based on the weight of stucco.

TABLE 11
FEI of Boards Made with Various Amounts of Silicate

| | | Silicate as | | | | Shrinkage | |
|---|---|---|---|---|---|---|---|
| | | Received/ | Board | | | area (%)/ | |
| | Silicate | Active | Basis | | | Shrinkage by | |
| | (lbs/ | Silicate | Weight | Caliper | Vermiculite | thickness | FEI |
| Sample | MSF) | (%) | (lbs/MSF) | (inch) | (lbs/MSF) | (%) | (min) |
| 1 | 0 | 0 | 1542 | 0.639 | 44 | −4.6/−2.6 | 52.2 |
| 2 | 5.9 | 0.40/0.15 | 1572 | 0.644 | 45 | −2.3/−6.1 | 55.8 |
| 3 | 11.5 | 0.80/0.30 | 1533 | 0.643 | 44 | −2.2/−3.2 | 54.7 |
| 4 | 23.2 | 1.59/0.60 | 1548 | 0.643 | 45 | −3.1/−5.2 | 54.6 |
| 5 | 36.4 | 2.39/0.90 | 1612 | 0.634 | 47 | −4.6/1.7 | 55.2 |

This Example demonstrates that metal silicates added to stucco slurry can increase the fire endurance of the gypsum wallboard.

### Example 3

### Determination of Optimum Amount of Silicates

This Example determines the optimum silicate content for fire endurance and compressive strength. In addition, this Example examines the effect of silicate neutralization on fire endurance and compressive strength. Accordingly, nine gypsum boards (samples 6-14) were made with active sodium silicate amounts ranging from 0% to 0.25% by weight based on the weight of stucco. In addition, a constant water-to-stucco ratio of 1.0 and a variable amount of foam were used to obtain the desired board weight.

In a laboratory, a 3% silicate solution was prepared by mixing 30 grams of sodium silicate (PQ Corp's N®, 37.5% concentration, pH 11.3, SiO₂/Na₂O=3.22) and 970 mL tap water. The solution was adjusted to a pH of about 6.9. The solution was freshly prepared to make each board. To individual steel bowls was added 0 g silicate solution (samples 6 and 12), 50 g silicate solution (sample 7), 100 g silicate solution (sample 8), 150 g silicate solution (sample 9), 200 g silicate solution (sample 10), and 250 g silicate solution (sample 11). For samples 13 and 14, 100 g and 150 g of an un-neutralized silicate solution was added to steel bowls, respectively. Additional tap water was added to the bowls to reach a total weight of 900 g. To the water was added 2-3 drops of retarder (Dow Chemical, Versenex 90) and 0.5 g dispersant (GEO Specialty Chemicals, Diloflo Calif.). In eight separate bowls was mixed 900 g of stucco, 5.2 g of chopped fiberglass (Owens Corning, Advantex 790C-16W), 34.6 g of vermiculite (Virginia Vermiculite, grade 4), 15.1 g of pregelatinized starch (Bunge Milling, USG-95), 2.3 g of accelerator (USG, ground gypsum), and 1.0 g sodium trimetaphosphate (Innophos). Each stucco mixture was poured into the steel bowl containing the silicate/retarder/dispersant mixture, which was installed under a Hobart mixer. The mixture was immediately mixed and injected with foam. After 18 seconds, foam injection was stopped and the stucco slurry was mixed for another 12 seconds. The stucco slurry was then immediately poured into a premade paper envelop (with 50 lbs/1000 ft² manila and 62 lbs/1000 ft² newsline, 1 ft×1 ft). The envelope containing the stucco slurry was sandwiched between two aluminum plates that were spaced to make ⅝ inch boards. The gypsum was allowed to set. The boards were placed into an oven preset at 350° F. (177° C.) for 30 minutes, and then the boards were transferred to another oven preset at 110° F. (43° C.). The boards were dried in the oven for two nights. The dried boards were cut into sizes of 6.625 inches×6.125 inches boards.

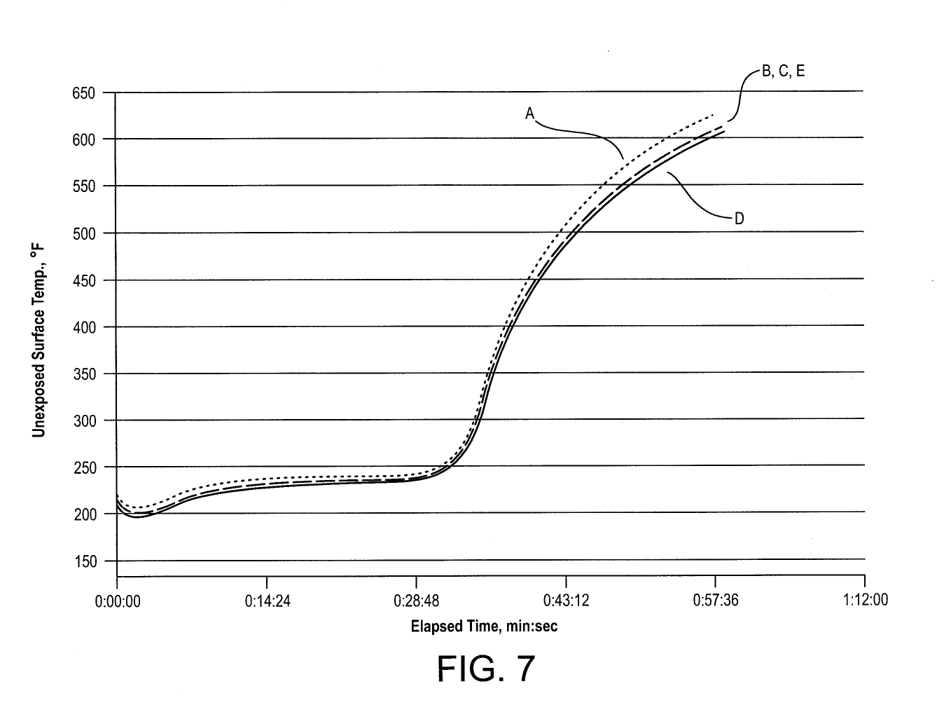

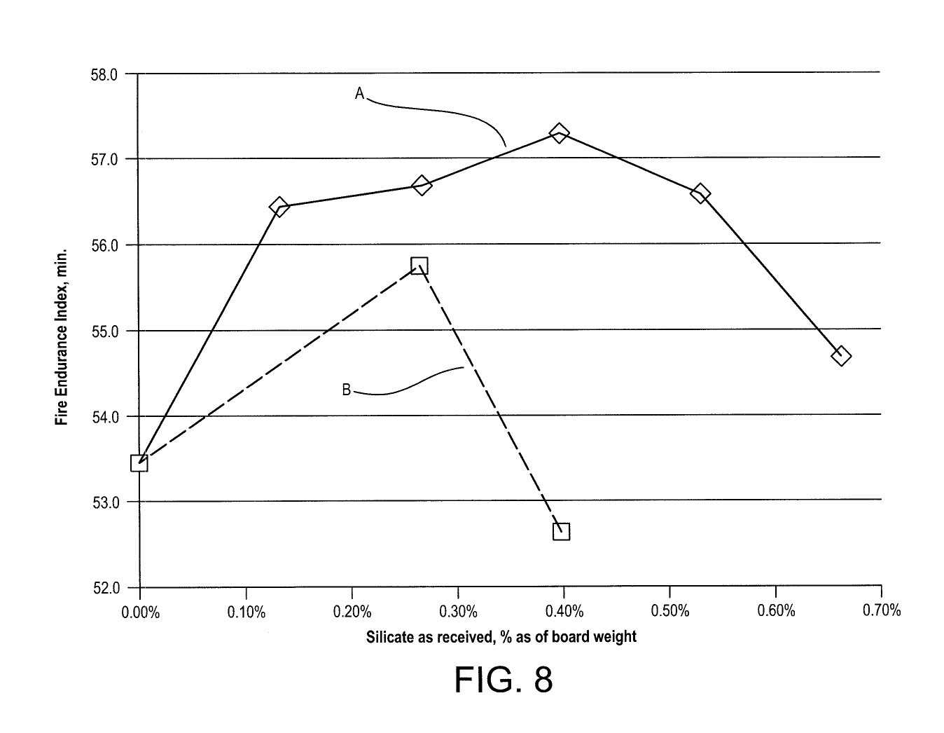

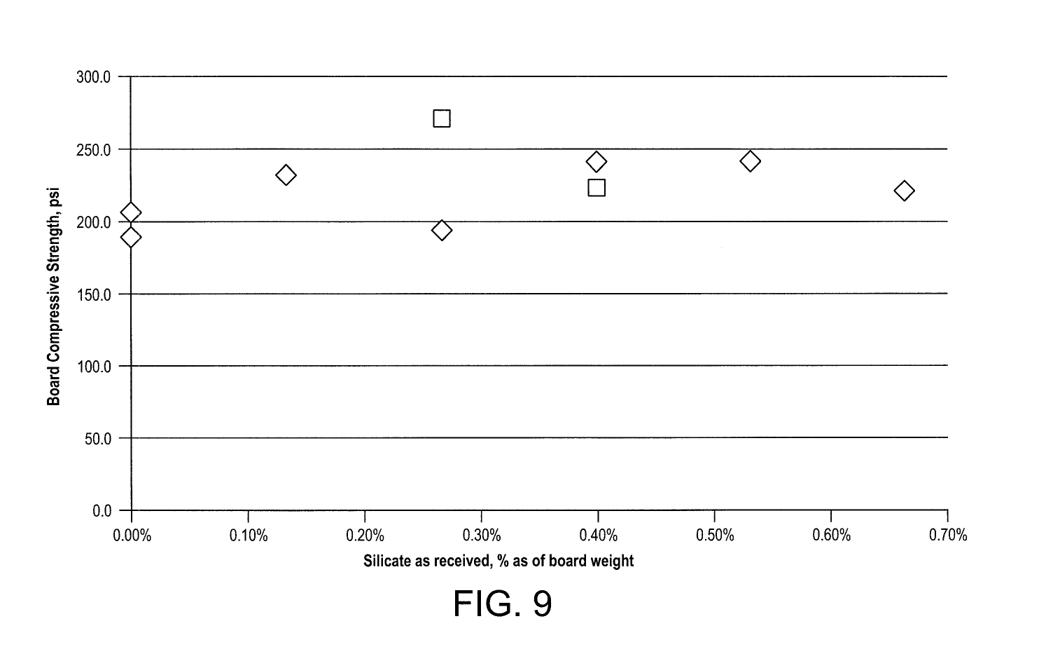

Samples 6-14 were individually tested in the small-scale device (FIG. 2) to determine their respective FEI and an ATS (Applied Testing System) machine to determine their respective compressive strengths. Temperature traces for samples 6-10 are shown in FIG. 7, where time is plotted along the horizontal axis and the unexposed surface temperature of the back-face of each sample is plotted along the vertical axis. In the graph of FIG. 7, line A represents the temperature trace for the control board (sample 6), line B represents the temperature trace for a board formed from a slurry having 0.05% active sodium silicate (sample 7), line C represents the temperature trace for a board formed from a slurry having 0.10% active sodium silicate (sample 8), line D represents the temperature trace for a board formed from a slurry having 0.15% active sodium silicate (sample 9), and line E represents the temperature trace for a board formed from a slurry having 0.20% active sodium silicate (sample 10). FIG. 8 shows how the amount of silicate affects the Fire Endurance Index, where the wt. % of silicate as received is plotted along the horizontal axis and the FEI is plotted along the vertical axis. Line A represents the trace for neutralized silicates and Line B represents the trace for un-neutralized silicates. FIG. 9 shows how the amount of silicate affects compressive strength, where the wt. % of silicate as received is plotted along the horizontal axis and the compressive strength (psi) is plotted along the vertical axis. In FIG. 9, the diamonds represent the neutralized silicate data and the squares represent the un-neutralized silicate data.

As can be calculated from the graph of FIG. 7, the FEI of the control board was 53.4 minutes (sample 6), 56.4 minutes for the board formed from a slurry having 0.05% active sodium silicate (sample 7), 56.7 minutes for the board formed from a slurry having 0.10% active sodium silicate (sample 8), 57.3 minutes for the board formed from a slurry having 0.15% active sodium silicate (sample 9), and 56.6 minutes for the board formed from a slurry having 0.20% active sodium silicate (sample 10). As shown in Table 12, the FEI for a board formed from a slurry having 0.25% active sodium silicate is 54.7 minutes (sample 11). The FEI of sample 12 was not determined. This Example confirms that 0.15% active silicate is optimal, providing a FEI increase of 3.9 minutes when compared to the control. Furthermore, a FEI increase of up to 3 minutes can be achieved using 0.05% active silicate. As can be seen in FIG. 8, the board formed from a slurry comprising 0.40% silicate as received (i.e., 0.15% active silicate) increased the FEI by 3.9 minutes (sample 9). FIG. 8 suggests that the FEI may peak with a silicate as received content of 0.40% (i.e., 0.15% active silicate).

The samples were individually tested using an ATS (Applied Testing System) machine to determine their respective compressive strengths. As shown in FIG. 9, compressive strength also increases when sodium silicate is added to stucco slurry. A board formed from a slurry comprising 0.15% active silicate had a compressive strength of 242.2 psi. A board formed from a slurry comprising 0.20 wt. % active silicate provided a compressive strength of 241.7 psi. As can be calculated from FIG. 9, the addition of silicates increased compressive strength an average of 18%.

TABLE 12
Determination of Optimal Silicate Amount

| | | Silicate as | | | | | |
|---|---|---|---|---|---|---|---|
| | | Received/ | | | | | |
| | Silicate | Active | Board | | Vermiculite | | |
| | (lbs/ | Silicate | Basis Weight | Caliper | (lbs/ | Compressive | FEI |
| Sample | 1000 ft²) | (%) | (lbs/1000 ft²) | (inch) | 1000 ft²) | Strength (psi) | (min) |
| 6 | 0 | 0 | 1770 | 0.64 | 51 | 206.2 | 53.4 |
| 7 | 2.1 | 0.13/0.05 | 1724 | 0.631 | 49 | 232.9 | 56.4 |
| 8 | 4.3 | 0.27/0.10 | 1744 | 0.642 | 50 | 195.4 | 56.7 |
| 9 | 6.4 | 0.40/0.15 | 1718 | 0.642 | 49 | 242.2 | 57.3 |
| 10 | 8.8 | 0.53/0.20 | 1765 | 0.637 | 51 | 241.7 | 56.6 |
| 11 | 10.6 | 0.66/0.25 | 1712 | 0.647 | 49 | 221.7 | 54.7 |
| 12 | 0 | 0 | 1832 | 0.639 | 53 | 189.7 | — |

When boards were formed from stucco comprising silicate having a pH of 11.3, an improvement in the FEI was also observed (see Table 13) As shown in Table 13, the FEI of sample 13 was greater than for the control board (sample 6). A FEI of 55.8 minutes was observed for a board formed from a slurry comprising 0.10 wt. % active silicate having a pH of 11.3 (sample 13) and a FEI of 52.6 minutes was observed for a board made with 0.15 wt. % active silicate having a pH of 11.3 (sample 14). A shown by FIG. 8 as represented by Line B, the FEI peaks when 0.10 wt. % active silicate is used, and drops off when 0.1 wt. % active silicate is used.

As shown in Table 13, the compressive strength of both samples increased when compared to the control board. However, without neutralization of the silicates, the fluidity of the stucco slurry significantly increased.

TABLE 13
FEI and Compressive Strength of Boards Comprising Un-neutralized Silicate

| | | Silicate as | Board | | | | |
|---|---|---|---|---|---|---|---|
| | | Received/ | Basis | | | | |
| | Silicate | Active | Weight | | Vermiculite | Compressive | |
| | (lbs/ | Silicate | (lbs/ | Caliper | (lbs/ | Strength | FEI |
| Sample | 1000 ft²) | (%) | 1000 ft²) | (inch) | 1000 ft²) | (psi) | (min) |
| 6 | 0 | 0 | 1770 | 0.64 | 51 | 206.2 | 53.4 |
| 13 | 4.3 | 0.27/0.10 | 1728 | 0.638 | 50 | 271.3 | 55.8 |
| 14 | 6.5 | 0.40/0.15 | 1743 | 0.63 | 50 | 225.1 | 52.6 |

This Example demonstrates that 0.15% active neutralized silicate is optimal and can significantly increase the fire endurance and compressive strength of wallboard. This Example also demonstrates that neutralization is not required to obtain an increase in fire endurance or compressive strength.

### Example 4

### Effect of Silicate on Fire Endurance in the Absence of Vermiculite

This Example demonstrates the effect of silicate, in the absence of vermiculite, on fire endurance of wallboard. Accordingly, gypsum boards were made with sodium silicate of various amounts. In addition, a constant water-to-stucco ratio of 1.0 and variable amount of foam were used to obtain the desired board weight.

In a laboratory, a 3% silicate solution was prepared by mixing 30 grams of sodium silicate (PQ Corp's N®, 37.5% concentration, pH 11.3, SiO₂/Na₂O=3.22) and 970 mL tap water. The solution was adjusted to a pH of about 7.0. The solution was freshly prepared to make each board. To individual steel bowls was added Og silicate solution, 25 g silicate solution, 50 g silicate solution, 100 g silicate solution, 150 g silicate solution, 200 g silicate solution, 250 g silicate solution. Additional tap water was added to the bowls to reach a total weight of 900 g. To the water was added 2-3 drops of retarder (Dow Chemical, Versenex 90) and 0.5 g dispersant (GEO Specialty Chemicals, Diloflo Calif.). In seven separate bowls was mixed 900 g of stucco, 5.2 g of chopped fiberglass (Owens Corning, Advantex 790C-16W), 15.1 g of pregelatinized starch (Bunge Milling, USG-95), 2.3 g of accelerator (USG, ground gypsum), and 1.0 g sodium trimetaphosphate (Innophos). Each stucco mixture was poured into the steel bowl containing the silicate/retarder/dispersant mixture, which was installed under a Hobart mixer. The mixture was immediately mixed and injected with foam. After 20 seconds, foam injection was stopped and the stucco slurry was mixed for another 10 seconds. The stucco slurry was then immediately poured into a premade paper envelop (with 50 lbs/1000 ft² manila and 62 lbs/1000 ft² newsline, 1 ft×1 ft). The envelope containing the stucco slurry was sandwiched between two aluminum plates that were spaced to make ⅝ inch boards. The gypsum was allowed to set. The boards were placed into an oven preset at 350° F. (177° C.) for 30 minutes, and then the boards were transferred to another oven preset at 110° F. (43° C.). The boards were dried in the oven for two nights. The dried boards were cut into sizes of 6.625 inches×6.125 inches boards.

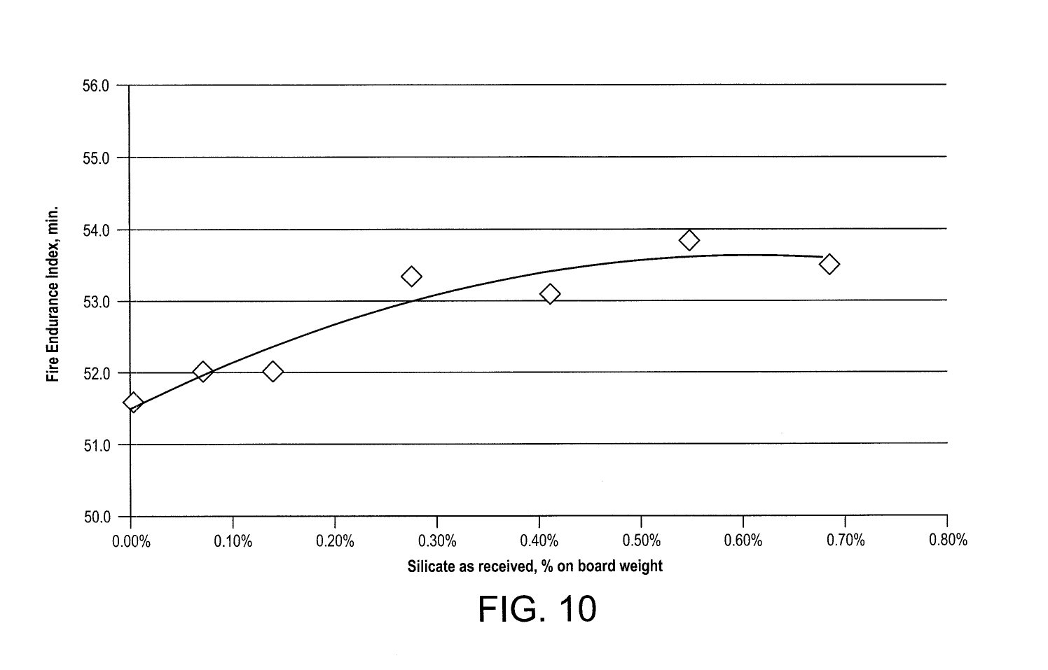

The samples were individually tested in the small-scale device (FIG. 2) to determine their respective FEI. The FEI for each sample was plotted in FIG. 10, where the silicate as received (wt. %) is plotted along the horizontal axis and the FEI is plotted along the vertical axis. As shown in FIG. 10, in the absence of vermiculite, an increase in fire endurance is observed. A maximum FEI increase of 2.2 minutes was observed when board is formed from a slurry comprising 0.55% silicates as received (i.e., 0.21% active silicate).

This Example demonstrates that in the absence of vermiculite, the addition of sodium silicate can increase the fire endurance of gypsum wallboard.

### Example 5

### Effect of Silicate on Compressive Strength

This Example demonstrates the effect of silicate on the compressive strength of wallboard. In addition, the board was made without foam injection so that the strength variation generated by foam is eliminated. Accordingly, gypsum boards were made with sodium silicate of various amounts. Water rather than foam was used to control the density of the board. As a result, a constant water-to-stucco ratio of 1.85 was used.

In a laboratory, a 3% silicate solution was prepared by mixing 30 grams of sodium silicate (PQ Corp's N®, 37.5% concentration, pH 11.3, SiO₂/Na₂O=3.22) and 970 mL tap water. The solution was adjusted to a pH of about 7.0. The solution was freshly prepared to make each board. To individual steel bowls was added 0 g silicate solution, 25 g silicate solution, 50 g silicate solution, 100 g silicate solution, 150 g silicate solution, 200 g silicate solution, 250 g silicate solution. Additional tap water was added to the bowls to reach a total weight of 1665 g. To the water was added 0.5 g dispersant (GEO Specialty Chemicals, Diloflo Calif.). In seven separate bowls was mixed 900 g of stucco, 5.2 g of chopped fiberglass (Owens Corning, Advantex 790C-16W), 15.1 g of pregelatinized starch (Bunge Milling, USG-95), 2.3 g of accelerator (USG, ground gypsum), and 1.0 g sodium trimetaphosphate (Innophos). Each stucco mixture was poured into the steel bowl containing the silicate/retarder/dispersant mixture, which was installed under a Hobart mixer. The mixture was immediately mixed for 30 seconds. The stucco slurry was then immediately poured into a premade paper envelop (with 50 lbs/1000 ft² manila and 62 lbs/1000 ft² newsline, 1 ft×1 ft). The envelope containing the stucco slurry was sandwiched between two aluminum plates that were spaced to make ⅝ inch boards. The gypsum was allowed to set. The boards were placed into an oven preset at 350° F. (177° C.) for 30 minutes, and then the boards were transferred to another oven preset at 110° F. (43° C.). The boards were dried in the oven for two nights. The dried boards were cut into circles having a 3 inch diameter.

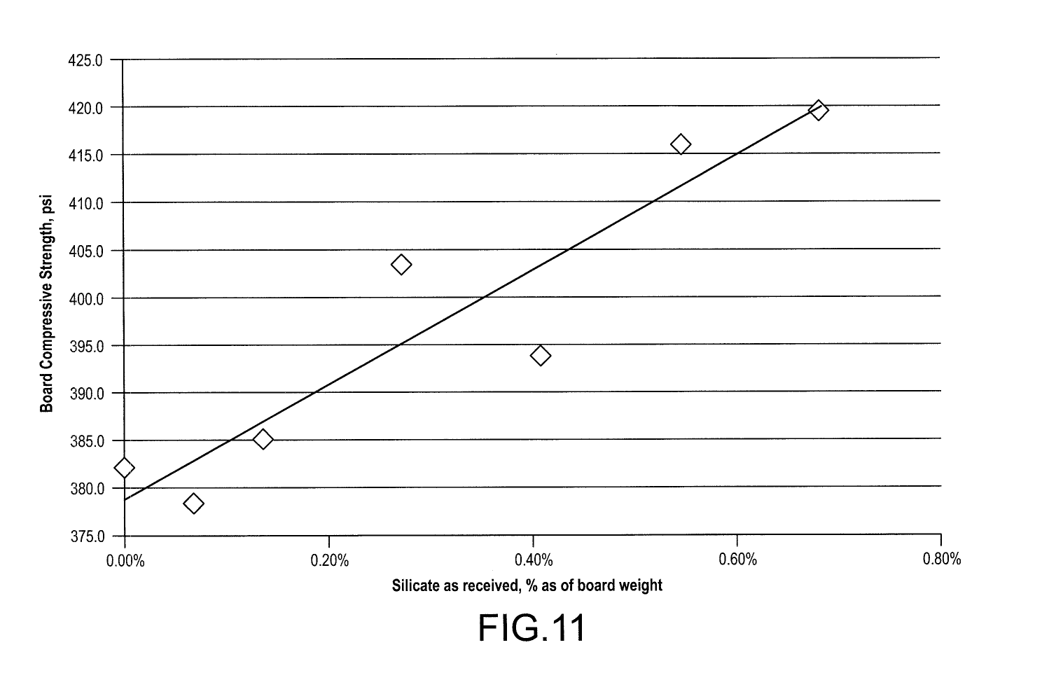

The samples were individually tested using an ATS (Applied Testing System) machine to determine their respective compressive strengths. The compressive strength of each sample was plotted in FIG. 11, where the silicate as received (wt %) is plotted along the horizontal axis and the board compressive strength (psi) is plotted along the vertical axis. As shown in FIG. 11, an increase in compressive strength is observed. A maximum compressive strength increase of 270 psi was observed when a board was formed from a stucco slurry comprising 0.25% silicate as received (i.e., 0.09% active silicate).

This Example demonstrates that silicates can increase the compressive strength of gypsum wallboard.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Also, everywhere “comprising” (or its equivalent) is recited, the “comprising” is considered to incorporate “consisting essentially of” and “consisting of:” Thus, an embodiment “comprising” (an) element(s) supports embodiments “consisting essentially of” and “consisting of” the recited element(s). Everywhere “consisting essentially of” is recited is considered to incorporate “consisting of:” Thus, an embodiment “consisting essentially of” (an) element(s) supports embodiments “consisting of” the recited element(s). Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A gypsum board comprising:
a set gypsum composition disposed between two cover sheets, the set gypsum composition comprising an interlocking matrix of set gypsum formed from a slurry comprising stucco, water, and metal silicate;
the set gypsum composition comprising silica gel; and
the gypsum board having a density from about 15 lbs/ft³ to about 42 lbs/ft³ and a Fire Endurance Index greater than about 53 minutes.

2. The gypsum board of claim 1, wherein the metal silicate is sodium silicate, potassium silicate, lithium silicate, or a combination thereof.

3. The gypsum board of claim 1, wherein the metal silicate (in an active basis) is in an amount from about 0.01% to about 1% by weight based on the weight of stucco.

4. The gypsum board of claim 1, wherein prior to addition to the slurry, the metal silicate is included in a solution having a pH from about 5 to about 10.

5. The gypsum board of claim 1, wherein the metal silicate has a SiO₂ to metal oxide ratio from about 0.5 to about 5.0.

6. The gypsum board of claim 1, wherein the set gypsum composition further comprises vermiculite in an amount less than about 5% by weight based on the weight of the stucco.

7. The gypsum board of claim 1, wherein the gypsum board has a silica gel to metal silicate weight ratio from about 1 to 1 to about 99 to 1.

8. The gypsum board of claim 1, wherein the gypsum board has a silica gel to metal silicate weight ratio greater than about 99 to 1.

9. The gypsum board of claim 1, wherein the gypsum board has a density from about 15 lbs/ft³ to about 35 lbs/ft³.

10. The gypsum board of claim 1, wherein the gypsum board has a dry weight of less than about 2000 lbs/1000 ft² when at a thickness of about ⅝ inch.

11. The gypsum board of claim 1, wherein the silica gel is in an amount effective to increase the compressive strength of the gypsum board relative to the compressive strength of a gypsum board without the silica gel.

12. The gypsum board of claim 1, wherein the gypsum board has the Fire Endurance Index (FEI) of at least about 3 minutes greater than a gypsum board having no silica gel.

13. The gypsum board of claim 1, wherein the gypsum board is built into a test assembly in accordance with UL U305, and has a fire rating of at least about 55 minutes when heated in accordance with the time-temperature curve of ASTM standard E119-09.

14. The gypsum board of claim 1, wherein the gypsum board is built into a test assembly in accordance with UL U305, and has a fire rating of at least about 60 minutes when heated in accordance with the time-temperature curve of ASTM standard E119-09.

15. The gypsum board of claim 1, wherein the gypsum board is built into a test assembly in accordance with UL U419, and has a fire rating of at least about 60 minutes when heated in accordance with the time-temperature curve of ASTM standard E119-09.

16. The gypsum board of claim 1, wherein the gypsum board has a thickness from about 0.59 inches to about 0.65 inches.

17. The gypsum board of claim 1, wherein the slurry has a water-to-stucco ratio from about 1.0 to about 2.0.

18. The gypsum board of claim 1, wherein at least one of the two cover sheets has a basis weight greater than about 60 lbs/1000 ft².

19. A method of increasing fire endurance of a gypsum board comprising:
forming a slurry comprising stucco, water, and metal silicate,
disposing the slurry between two cover sheets to form a board preform,
cutting the board preform into a gypsum board of predetermined dimensions after the slurry has hardened sufficiently for cutting, and
drying the gypsum board;
wherein at least a portion of the metal silicate converts to silica gel;
the gypsum board having increased fire endurance as compared to a board having no silica gel, a density from about 15 lbs/ft³ to about 42 lbs/ft³, and a Fire Endurance Index greater than about 53 minutes.

20. The method of claim 19, further comprising including the metal silicate in a solution having a pH of about 5 to about 10 prior to forming the slurry.
